(19) United States
(12) Patent Application Publication
(10) Pub. No.: US 2026/0127692 A1
(43) Pub. Date: May 7, 2026

(54) NEGOTIATION APPARATUS, NEGOTIATION METHOD, AND STORAGE MEDIUM

(71) Applicant: NEC Corporation, Minato-ku, Tokyo (JP)

(72) Inventors: Tomohito ANDO, TOKYO (JP); Satoshi MORINAGA, TOKYO (JP); Shinji NAKADAI, TOKYO (JP)

(73) Assignee: NEC Corporation, Minato-ku, Tokyo (JP)

(21) Appl. No.: 19/118,025

(22) PCT Filed: Oct. 13, 2022
(86) PCT No.: PCT/JP2022/038197

§ 371 Date: Apr. 3, 2025

(51) Int. Cl. G06Q 50/18

(52) U.S. Cl. CPC G06Q 50/188

(57) ABSTRACT

In order that the problem of providing a technique for conducting a negotiation which includes a plurality of deadlines can be solved, the negotiation apparatus (1) includes an agreement candidate proposal acquiring section (11) for acquiring, in a negotiation with a negotiation party which is a negotiating partner, a first agreement candidate proposal which is provided by the negotiation party and which includes a plurality of first deadlines; and a judging section (12) for judging whether to agree to the first agreement candidate proposal.

### TECHNICAL FIELD

The present invention relates to a technique for conducting a negotiation.

### BACKGROUND ART

Patent Literature 1 discloses a system for receiving an order from a requester, dividing the order on the basis of the result of a preliminary load check, and formulating a production plan on the basis of the order divided.

### CITATION LIST

### Patent Literature

### Patent Literature 1

Japanese Patent Application Publication Tokukai No. 2009-223785

### SUMMARY OF INVENTION

### Technical Problem

In a case of dividing an order as in the system disclosed in Patent Literature 1, it is necessary to negotiate with a requester on a plurality of deadlines. However, Patent Literature 1 does not disclose a negotiation regarding a plurality of deadlines. An example aspect of the present invention has been made in view of the above problem, and an example object thereof is to provide a technique for conducting a negotiation regarding a plurality of deadlines.

### Solution to Problem

A negotiation apparatus in accordance with an example aspect of the present invention includes: an agreement candidate proposal acquiring means for acquiring, in a negotiation with a negotiation party which is a negotiating partner, a first agreement candidate proposal which is provided by the negotiation party and which includes a plurality of first deadlines; and a judging means for judging whether to agree to the first agreement candidate proposal.

A negotiation apparatus in accordance with an example aspect of the present invention includes: an agreement candidate proposal generating means for generating, in a negotiation with a negotiation party which is a negotiating partner, an agreement candidate proposal which is to be provided to the negotiation party and which includes a plurality of deadlines; and an agreement candidate proposal providing means for providing the negotiation party with the agreement candidate proposal.

A negotiation method in accordance with an example aspect of the present invention includes: a computer acquiring, in a negotiation with a negotiation party which is a negotiating partner, a first agreement candidate proposal which is provided by the negotiation party and which includes a plurality of first deadlines; and the computer judging whether to agree to the first agreement candidate proposal.

A negotiation method in accordance with an example aspect of the present invention includes: a computer generating, in a negotiation with a negotiation party which is a negotiating partner, an agreement candidate proposal which is to be provided to the negotiation party and which includes a plurality of deadlines; and the computer providing the negotiation party with the agreement candidate proposal.

A program in accordance with an example aspect of the present invention causes a computer to function as: an agreement candidate proposal acquiring means for acquiring, in a negotiation with a negotiation party which is a negotiating partner, a first agreement candidate proposal which is provided by the negotiation party and which includes a plurality of first deadlines; and a judging means for judging whether to agree to the first agreement candidate proposal.

A program in accordance with an example aspect of the present invention causes a computer to function as: an agreement candidate proposal generating means for generating, in a negotiation with a negotiation party which is a negotiating partner, an agreement candidate proposal which is to be provided to the negotiation party and which includes a plurality of deadlines; and an agreement candidate proposal providing means for providing the negotiation party with the agreement candidate proposal.

### Advantageous Effects of Invention

With an example aspect of the present invention, it is possible to provide a technique for conducting a negotiation regarding a plurality of deadlines.

### BRIEF DESCRIPTION OF DRAWINGS

FIG. 1 is a block diagram illustrating a configuration of a negotiation apparatus in accordance with a first example embodiment of the present invention.

FIG. 2 is a flowchart illustrating a flow of a negotiation method in accordance with the first example embodiment of the present invention.

FIG. 3 is a block diagram illustrating a configuration of a negotiation apparatus in accordance with a second example embodiment of the present invention.

FIG. 4 is a flowchart illustrating a flow of a negotiation method in accordance with the second example embodiment of the present invention.

FIG. 5 is a block diagram illustrating a configuration of a negotiation system in accordance with a third example embodiment of the present invention.

FIG. 6 is a block diagram illustrating an example functional configuration of the negotiation apparatus illustrated in FIG. 5.

FIG. 7 is a block diagram illustrating an example functional configuration of another negotiation apparatus illustrated in FIG. 5.

FIG. 8 is a flowchart illustrating a flow of a negotiation method in accordance with the third example embodiment of the present invention.

FIG. 9 is a flowchart illustrating a flow of another negotiation method in accordance with the third example embodiment of the present invention.

FIG. 10 is a diagram illustrating an example transition of screens and processes in a specific example of the negotiation methods illustrated in FIG. 8 and FIG. 9.

FIG. 11 is a diagram illustrating a detailed example of a screen illustrated in FIG. 10.

FIG. 12 is a diagram illustrating a detailed example of another screen illustrated in FIG. 10.

FIG. 13 is a diagram illustrating a detailed example of still another screen illustrated in FIG. 10.

FIG. 14 is a diagram illustrating a detailed example of still another screen illustrated in FIG. 10.

FIG. 15 is a diagram illustrating a detailed example of still another screen illustrated in FIG. 10.

FIG. 16 is a diagram illustrating a detailed example of still another screen illustrated in FIG. 10.

FIG. 17 is a diagram illustrating a detailed example of yet still another screen illustrated in FIG. 10.

FIG. 18 is a representation of an example algorithm for generating a plurality of agreement candidate proposals in the third example embodiment of the present invention.

FIG. 19 is a graph illustrating an example of the plurality of agreement candidate proposals based on the algorithm of FIG. 18.

FIG. 20 is a block diagram illustrating a configuration of a negotiation system in accordance with a variation of the third example embodiment.

FIG. 21 is a diagram illustrating an example hardware configuration of the apparatuses in accordance with the example embodiments.

### EXAMPLE EMBODIMENTS

In the following description, a “negotiation party” refers to, for example, a party which has the ability to generate an agreement candidate proposal to be provided to another negotiation party and the ability to determine whether to agree to an agreement candidate proposal acquired from another negotiation party. The negotiation party may be an apparatus, may be a human being, or may be an organization. A “negotiation apparatus” refers to, for example, an apparatus which functions as the negotiation party. The “negotiation apparatus” can also refer to, for example, an apparatus which functions on the basis of operations performed by a human being who is the negotiation party or a human being who belongs to an organization that is the negotiation party. Examples of the negotiation apparatus include a computer, a robot, a drone, and a self-driving vehicle. Further, a “negotiation” refers to, for example, provisions of an agreement candidate proposal which alternate between negotiation parties until the formation of agreement is achieved between the negotiation parties. The negotiation may be a negotiation between parties the interests of which conflict, or may be a negotiation (adjustment) between parties the interests of which do not conflict.

Note that the following description is presented under the assumption that a bilateral negotiation is conducted by two negotiation parties which share a set of agreement candidate proposals. However, this assumption is for convenience of description, and a multilateral negotiation conducted by three or more negotiation parties is within the scope of the present invention.

### First Example Embodiment

The following description will discuss a first example embodiment of the present invention in detail with reference to the drawings. The present example embodiment is basic to example embodiments which will be described later.

### Configuration of Negotiation Apparatus 1

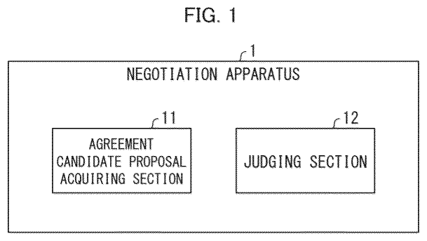

The configuration of a negotiation apparatus 1 in accordance with the present example embodiment is described here with reference to FIG. 1. FIG. 1 is a block diagram illustrating the configuration of the negotiation apparatus 1. The negotiation apparatus 1 includes an agreement candidate proposal acquiring section 11 and a judging section 12, as illustrated in FIG. 1. The agreement candidate proposal acquiring section 11 acquires, in a negotiation with a negotiation party which is a negotiating partner, a first agreement candidate proposal which is provided by the negotiation party and which includes a plurality of first deadlines. The judging section 12 judges whether to agree to the first agreement candidate proposal.

### Implementation Via Program

The functions of the negotiation apparatus 1 above can be implemented via a program. A program in accordance with the present example embodiment causes a computer to function as the agreement candidate proposal acquiring section 11 for acquiring, in a negotiation with a negotiation party which is a negotiating partner, a first agreement candidate proposal which is provided by the negotiation party and which includes a plurality of first deadlines; and the judging section 12 for judging whether to agree to the first agreement candidate proposal.

### Flow of Negotiation Method S1

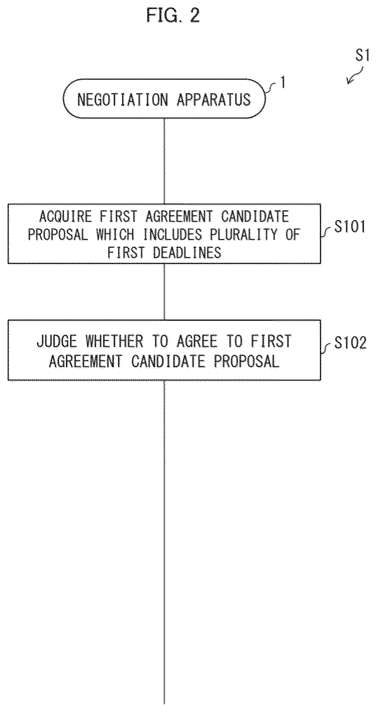

The flow of a negotiation method S1 in accordance with the present example embodiment is described here with reference to FIG. 2. FIG. 2 is a flowchart illustrating the flow of the negotiation method S1. The negotiation method S1 includes steps S101 and S102, as illustrated in FIG. 2. In step S101, the computer acquires, in a negotiation with a negotiation party which is a negotiating partner, a first agreement candidate proposal which is provided by the negotiation party and which includes a plurality of first deadlines. In step S102, the computer judges whether to agree to the first agreement candidate proposal.

### Example Advantage of Present Example Embodiment

As above, a configuration adopted in the negotiation apparatus 1, the program, and the negotiation method S1 in accordance with the present example embodiment is such that a first agreement candidate proposal which is provided by a negotiation party that is a negotiating partner and which includes a plurality of first deadlines is acquired in a negotiation with the negotiation party, and whether to agree to the first agreement candidate proposal is judged. Thus, with the present example embodiment, it is possible to conduct a negotiation regarding a plurality of deadlines.

### Second Example Embodiment

The following description will discuss a second example embodiment of the present invention in detail with reference to the drawings. The present example embodiment is basic to an example embodiment which will be described later.

### Configuration of Negotiation Apparatus 2

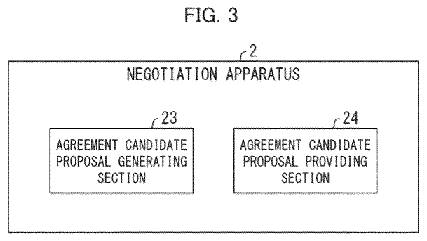

The configuration of a negotiation apparatus 2 in accordance with the present example embodiment is described here with reference to FIG. 3. FIG. 3 is a block diagram illustrating the configuration of the negotiation apparatus 2. The negotiation apparatus 2 includes an agreement candidate proposal generating section 23 and an agreement candidate proposal providing section 24, as illustrated in FIG. 3. The agreement candidate proposal generating section 23 generates, in a negotiation with a negotiation party which is a negotiating partner, an agreement candidate proposal which is to be provided to the negotiation party and which includes a plurality of deadlines. The agreement candidate proposal providing section 24 provides the negotiation party with the agreement candidate proposal.

### Implementation Via Program

The functions of the negotiation apparatus 2 above can be implemented via a program. A program in accordance with the present example embodiment causes a computer to function as the agreement candidate proposal generating section 23 for generating, in a negotiation with a negotiation party which is a negotiating partner, an agreement candidate proposal which is to be provided to the negotiation party and which includes a plurality of deadlines, and an agreement candidate proposal providing section 24 for providing the negotiation party with the agreement candidate proposal.

### Flow of Negotiation Method S2

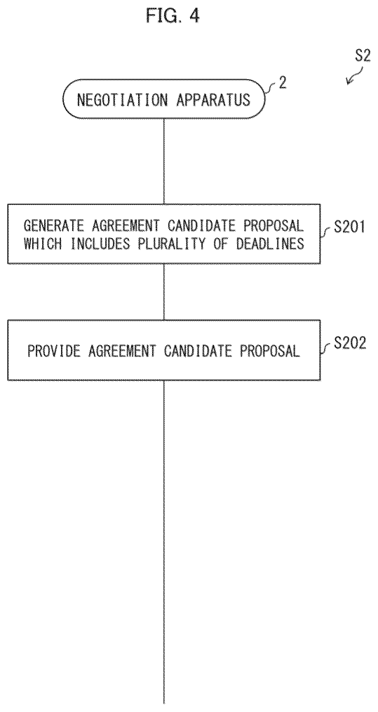

The flow of a negotiation method S2 in accordance with the present example embodiment is described here with reference to FIG. 4. FIG. 4 is a flowchart illustrating the flow of the negotiation method S2. The negotiation method S2 includes steps S201 and S202, as illustrated in FIG. 4. In step S201, the computer generates, in a negotiation with a negotiation party which is a negotiating partner, an agreement candidate proposal which is to be provided to the negotiation party and which includes a plurality of deadlines. In step S202, the computer provides the negotiation party with the agreement candidate proposal.

### Example Advantage of Present Example Embodiment

As above, a configuration adopted in the negotiation apparatus 2, the program, and the negotiation method S2 in accordance with the present example embodiment is such that an agreement candidate proposal which is to be provided to a negotiation party that is a negotiating partner and which includes a plurality of deadlines is generated in a negotiation with the negotiation party, and the agreement candidate proposal is provided to the negotiation party. Thus, with the present example embodiment, it is possible to conduct a negotiation regarding a plurality of deadlines.

### Third Example Embodiment

The following description will discuss a third example embodiment of the present invention in detail with reference to the drawings. Note that a component having the same function as a component described in the first example embodiment is assigned the same reference sign, and the description thereof is omitted where appropriate.

### Configuration of Negotiation System 100

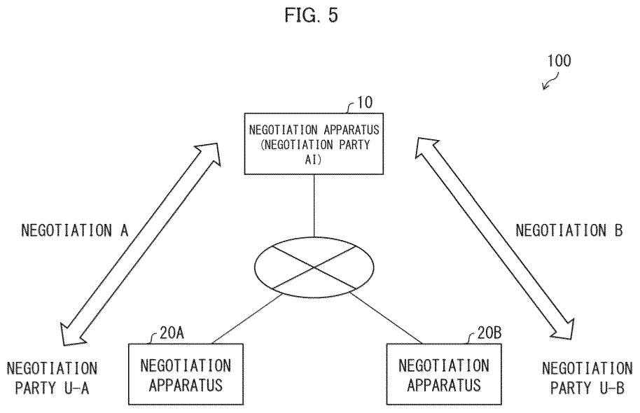

FIG. 5 is a block diagram illustrating a configuration of a negotiation system 100 in accordance with the present example embodiment. The negotiation system 100 includes a negotiation apparatus 10, a negotiation apparatus 20A, and a negotiation apparatus 20B, as illustrated in FIG. 5. The negotiation apparatus 10, the negotiation apparatus 20A, and the negotiation apparatus 20B are communicably connected together over a network.

The negotiation apparatus 10 functions as a negotiation party AI which conducts a negotiation with another negotiation party without relying on a user operation. The negotiation apparatus 20A is used by a negotiation party U-A, which is a human being or an organization, in order to conduct a negotiation with another negotiation party. The negotiation apparatus 20A has the function of conducting a negotiation with another negotiation party on the basis of operations of a human being who is the negotiation party U-A (or operations of a human being who belongs to an organization which is the negotiation party U-A). The negotiation apparatus 20B is used by a negotiation party U-B, which is a human being or an organization, in order to conduct a negotiation with another negotiation party. The negotiation apparatus 20B has the function of conducting a negotiation with another negotiation party on the basis of operations of a human being who is the negotiation party U-B (or operations of a human being who belongs to an organization which is the negotiation party U-B). Further, a negotiation A is conducted between the negotiation apparatus 10 and the negotiation party U-A, and a negotiation B is conducted between the negotiation apparatus 10 and the negotiation party U-B.

Each of the negotiation apparatuses 10, 20A, and 20B is an example of the negotiation apparatus recited in the claims. For example, in a case where the negotiation apparatus 10 (negotiation party AI) is applied as an example of the negotiation apparatus recited in the claims, the negotiation parties U-A and U-B can be applied as examples of the “negotiation party which is a negotiating partner”. Further, in a case where the negotiation apparatus 20A or the negotiation apparatus 20B is applied as an example of the negotiation apparatus recited in the claims, the negotiation apparatus 10 (negotiation party AI) can be applied as an example of the “negotiation party which is a negotiating partner”.

The negotiation apparatuses 10, 20A, and 20B each generate an agreement candidate proposal. The details of such generation will be described later. Further, the agreement candidate proposal includes a plurality of deadlines and a plurality of proposed quantities, and a cumulative proposed quantity can be calculated from the agreement candidate proposal. In a case where the negotiation apparatus 10 is an example of the negotiation apparatus, an agreement candidate proposal acquired by the negotiation apparatus 10 from each of the negotiation apparatuses 20A and 20B, deadlines and proposed quantities included in the agreement candidate proposal, and cumulative proposed quantities that can be calculated from the agreement candidate proposal are examples of the first agreement candidate proposal, the first deadlines and the first proposed quantities, and the first cumulative proposed quantities, respectively. Further, in this case, an agreement candidate proposal generated by the negotiation apparatus 10, deadlines and proposed quantities included in the agreement candidate proposal, and cumulative proposed quantities that can be calculated from the agreement candidate proposal are examples of the second agreement candidate proposal, the second deadlines and the second proposed quantities, and the second cumulative proposed quantities, respectively.

In a case where the negotiation apparatuses 20A and 20B are each an example of the negotiation apparatus, an agreement candidate proposal acquired by the negotiation apparatuses 20A and 20B from the negotiation apparatus 10, deadlines and proposed quantities included in the agreement candidate proposal, and cumulative proposed quantities that can be calculated from the agreement candidate proposal are examples of the first agreement candidate proposal, the first deadlines and the first proposed quantities, and the first cumulative proposed quantities, respectively. Further, in this case, an agreement candidate proposal generated by each of the negotiation apparatuses 20A and 20B, deadlines and proposed quantities included in the agreement candidate proposal, and cumulative proposed quantities that can be calculated from the agreement candidate proposal are examples of the second agreement candidate proposal, the second deadlines and the second proposed quantities, and the second cumulative proposed quantities, respectively.

### Specific Examples of Negotiation and Negotiation Party

The negotiation in the present example embodiment is a negotiation regarding an order for a product accepted from a negotiation party or a negotiation regarding an order for a product placed with a negotiation party. Specifically, a client A, which purchases a product, is applied as the negotiation party U-A, and a supplier B of the product is applied as the negotiation party U-B. Further, the negotiation apparatus 10, which is the negotiation party AI, functions as an agent for a middleman M. For example, the negotiation A is conducted in order for the middleman M to accept an order for a product from the client A. As a specific example, the negotiation A is conducted for changing an installment delivery plan A for the product between the client A and the middleman M. The negotiation B is conducted in association with the negotiation A, and is conducted in order for the middleman M to place an order for the product with the supplier B in response to acceptance of an order for the product from the client A. As a specific example, the negotiation B is conducted in order to change an installment delivery plan B for the product between the middleman M and the supplier B, in response to the change in the installment delivery plan A between the middleman M and the client A.

### Agreement Candidate Proposal

The negotiation apparatus 10 (negotiation party AI), the client A (negotiation party U-A), and the supplier B (negotiation party U-B) carry out the provision/acquisition of the agreement candidate proposals therebetween. Hereinafter, an agreement candidate proposal provided by the negotiation apparatus 10 to the client A in the negotiation A is also expressed as an agreement candidate proposal AI-A. An agreement candidate proposal provided by the client A to the negotiation apparatus 10 in the negotiation A is also expressed as an agreement candidate proposal U-A. An agreement candidate proposal provided by the negotiation apparatus 10 to the supplier B in the negotiation B is also expressed as an agreement candidate proposal AI-B. An agreement candidate proposal provided by the supplier B to the negotiation apparatus 10 in the negotiation B is also expressed as an agreement candidate proposal U-B. In a case where these agreement candidate proposals are not particularly distinguished from one another, the simple expression “agreement candidate proposal” is used.

For example, the agreement candidate proposal is referred to as an “offer”. In a case where an acquisition part which acquires an agreement candidate proposal (offer) does not agrees to the agreement candidate proposal, a new agreement candidate proposal (counter offer) can be generated by the acquisition part. Any of the agreement candidate proposals above can be a counter offer made in response to the other agreement candidate proposals.

### Deadline and Proposed Quantity

The agreement candidate proposal includes a plurality of deadlines and proposed quantities of a product that are proposed for respective deliveries corresponding to the plurality of deadlines. Product delivery which is divided so as to be made by a plurality of deadlines is also expressed as installment delivery.

For example, the agreement candidate proposal U-A includes a plurality of deadlines U-A which are proposed by the client A and proposed quantities U-A which correspond to the respective deadlines U-A. The agreement candidate proposal U-A indicates the quantities of products the deliveries of which are requested from the middleman M by the respective deadlines U-A desired by the client A. Further, for example, the agreement candidate proposal AI-A includes a plurality of deadlines AI-A which are proposed by the middleman M, and proposed quantities AI-A which correspond to the respective deadlines AI-A. The agreement candidate proposal AI-A indicates the quantities of products which are deliverable to the client A by the respective deadlines AI-A desired by the middleman M. Further, for example, the agreement candidate proposal AI-B includes a plurality of deadlines AI-B which are proposed by the middleman M, and proposed quantities AI-B which correspond to the respective deadlines AI-B. The agreement candidate proposal AI-B indicates the quantities of products the deliveries of which are requested from the supplier B by the respective deadlines AI-B desired by the middleman M. Further, for example, the agreement candidate proposal U-B includes a plurality of deadlines U-B which are proposed by the supplier B, and proposed quantities U-B which correspond to the respective deadlines U-B. The agreement candidate proposal U-B indicates the quantities of products which are deliverable to the middleman M by the respective deadlines U-B desired by the supplier B.

### Cumulative Proposed Quantity, Target Period, Point in Time

From the agreement candidate proposal, cumulative proposed quantities can be calculated. The cumulative proposed quantities each indicate the sum of the proposed quantities by a corresponding point in time in a target period. The target period includes a plurality of deadlines which are included in the agreement candidate proposal. Examples of the target period may include, but are not limited to, a period from the point in time at which a negotiation starts to the latest deadline which is included in the agreement candidate proposal. The points in time may be at intervals of a unit period. Examples of the unit period may include, but are not limited to, a one-day period.

### Configuration of Negotiation Apparatus 10

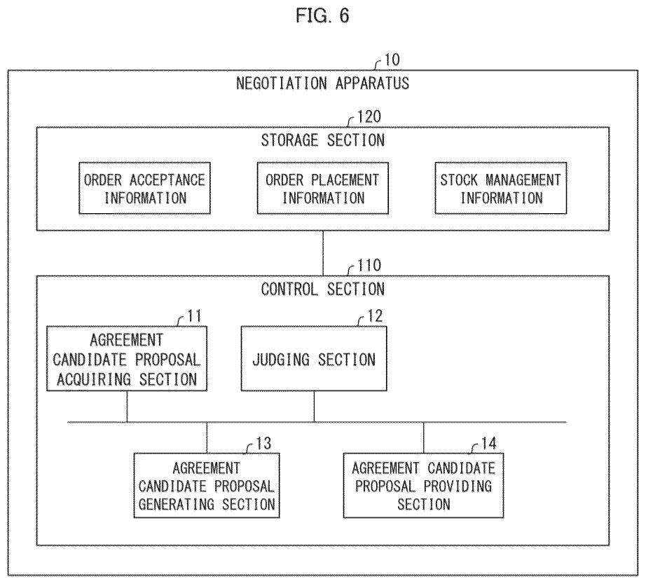

FIG. 6 is a block diagram illustrating an example functional configuration of the negotiation apparatus 10. The negotiation apparatus 10 includes a control section 110 and a storage section 120, as illustrated in FIG. 6. The control section 110 performs overall control of the sections of the negotiation apparatus 10. The control section 110 includes an agreement candidate proposal acquiring section 11, a judging section 12, an agreement candidate proposal generating section 13, and an agreement candidate proposal providing section 14. The storage section 120 stores order acceptance information, order placement information, and stock management information.

### Order Acceptance Information

The order acceptance information is information regarding an order for a product accepted from the client A. Information before the start of the negotiation A is indicated in the order acceptance information. The order acceptance information includes the installment delivery plan A for the client A regarding the product. For example, the installment delivery plan A includes a plurality of deadlines A, and delivery quantities A of the product which are planned to be delivered by the respective deadlines A. Required quantities, cumulative required quantities, cumulative planned delivery quantities U-A, and pre-negotiation cumulative planned delivery quantities U-A of the product can be calculated on the basis of the installment delivery plan A or the agreement candidate proposal U-A.

### Required Quantity, Cumulative Required Quantity

The required quantities are each the quantity of a product required by the middleman M by a corresponding point in time in the target period. Specifically, the required quantity indicates the quantity of a product required to be delivered from the supplier B, in response to acceptance of an order of the product from the client A. The cumulative required quantities are each the sum of the required quantities of a product required by a corresponding point in time in the target period. It is possible to calculate the cumulative required quantities from the required quantities at respective points in time. Before the start of the negotiation A, the required quantities at the respective points in time may be calculated by referring to the delivery quantities A included in the installment delivery plan A and a part or the whole of the stock management information, which will be described later. After the acquisition of the agreement candidate proposal U-A, the required quantities at the respective points in time may be calculated by referring to the proposed quantities U-A included in the agreement candidate proposal U-A and a part or the whole of the stock management information, which will be described later.

### Order Placement Information

The order placement information is information regarding an order for a product placed with the supplier B. Information before the start of the negotiation B is indicated in the order placement information. The order placement information includes the installment delivery plan B from the supplier B regarding the product. For example, the installment delivery plan B includes a plurality of deadlines B, and delivery quantities B of the product which are planned to be delivered by the respective deadlines B. Cumulative planned delivery quantities U-B and pre-negotiation cumulative planned delivery quantities U-B can be calculated on the basis of the installment delivery plan B or the agreement candidate proposal U-B.

### Cumulative Planned Delivery Quantity, Pre-Negotiation Cumulative Planned Delivery Quantity

The cumulative planned delivery quantities U-A are each the sum of the quantities of a product which are planned to be delivered from the middleman M to the client A by a corresponding point in time in the target period. For example, before the start of the negotiation A, the cumulative planned delivery quantities U-A are each the sum of the delivery quantities A by a corresponding point in time in the installment delivery plan A, which is planned before the start of the negotiation A. Hereinafter, such cumulative planned delivery quantities U-A before the start of the negotiation A are also expressed as “pre-negotiation cumulative planned delivery quantities U-A”. Further, for example, after the acquisition of the agreement candidate proposal U-A, the cumulative planned delivery quantities U-A are each the sum of the proposed quantities U-A by a corresponding point in time in the agreement candidate proposal U-A, and correspond to cumulative proposed quantities U-A. For example, after the acquisition of the agreement candidate proposal U-A, the cumulative planned delivery quantities U-B are each the sum of the proposed quantities U-A by a corresponding point in time in the agreement candidate proposal U-A, and correspond to the cumulative proposed quantities U-A.

The cumulative planned delivery quantities U-B are each the sum of the quantities of a product which are planned to be delivered from the supplier B to the middleman M by a corresponding point in time in the target period. For example, before the start of the negotiation B, the cumulative planned delivery quantities U-B are each the sum of the delivery quantities B by a corresponding point in time in the installment delivery plan B, which is planned before the start of the negotiation B. Hereinafter, such cumulative planned delivery quantities U-B before the start of the negotiation B are also expressed as “pre-negotiation cumulative planned delivery quantities U-B”. For example, after the acquisition of the agreement candidate proposal U-B, the cumulative planned delivery quantities U-B are each the sum of the proposed quantities U-B by a corresponding point in time in the agreement candidate proposal U-B, and correspond to the cumulative proposed quantities U-B.

### Stock Management Information

The stock management information is information for managing the stock of a product. For example, the stock management information includes the stock quantity, the minimum safety stock quantity, the maximum safety stock quantity, the safety lead time, and the standard packing quantity of a product. For example, by the stock quantity of a product, the stock quantity of the product before the start of the negotiation A and the negotiation B is indicated. Each of the minimum safety stock quantity, the maximum safety stock quantity, the safety lead time, and the standard packing quantity is set according to products. From the order acceptance information, the order placement information, and a part or the whole of the stock management information, cumulative valid stock quantities can be calculated.

### Cumulative Valid Stock Quantity

The cumulative valid stock quantities each indicate the minimum value, as of a corresponding point in time in the target period, of a planned stock quantity on and after the corresponding point in time. The planned delivery quantities are calculated by referring to the cumulative required quantities, the cumulative planned delivery quantities U-A and U-B, and a part or the whole of the stock management information.

### Configurations of Functional Blocks of Control Section 110

The agreement candidate proposal acquiring section 11 acquires, in the negotiation A with the client A, the agreement candidate proposal U-A which includes the plurality of deadlines U-A and the proposed quantities U-A corresponding to the respective deadlines U-A and which is provided by the client A. Specifically, the agreement candidate proposal acquiring section 11 acquires the agreement candidate proposal U-A from the client A by receiving this agreement candidate proposal U-A from the negotiation apparatus 20A. Hereinafter, “acquiring the agreement candidate proposal U-A provided by the client A” can be expressed as “receiving the agreement candidate proposal U-A from the negotiation apparatus 20A”. Hereinafter, the deadlines U-A can be expressed as the “deadlines U-A proposed by the client A”. Further, the proposed quantities U-A can be expressed as the “client A's proposed quantities U-A”. Note that the configuration of the agreement candidate proposal acquiring section 11 is described similarly even in the case of interchanging A with B.

In the negotiation A, the judging section 12 judges whether to agree to the agreement candidate proposal U-A. Further, in the negotiation B, the judging section 12 judges whether to agree to the agreement candidate proposal U-B.

Specific examples of a judgment criterion in the negotiation A, i.e., a judgment criterion in a case where the negotiation apparatus 10 is on the product order accepting side, includes the following example. For example, in the negotiation A, the judging section 12 may judge, based on a result of comparison between the cumulative proposed quantities U-A by respective points in time in the target period and the cumulative valid stock quantities of the product at the respective points in time in the target period, whether to agree to the agreement candidate proposal U-A.

The judging section 12 may refer to the minimum safety stock quantity, the maximum safety stock quantity, the safety lead time, or the standard packing quantity of the product, or a combination of some or all thereof, to judge whether to agree to the agreement candidate proposal U-A. For example, the judging section 12 may make the judgment by referring to cumulative valid stock calculated in consideration of a part or the whole of the stock management information.

Specific examples of a judgment criterion in the negotiation B, i.e., a judgment criterion in a case where the negotiation apparatus 10 is on the product order placing side, includes the following example. For example, in the negotiation B, the judging section 12 may judge, based on a result of comparison between the cumulative proposed quantities U-B by respective points in time in the target period and the cumulative required quantities of the product by the respective points in time in the target period, whether to agree to the agreement candidate proposal U-B.

The judging section 12 may refer to the minimum safety stock quantity, the maximum safety stock quantity, the safety lead time, or the standard packing quantity of the product, or a combination of some or all thereof, to judge whether to agree to the agreement candidate proposal U-B. For example, the judging section 12 may make the judgment by referring to cumulative required quantities calculated in consideration of a part or the whole of the stock management information.

The agreement candidate proposal generating section 13 generates the agreement candidate proposal AI-A which is to be provided to the client A in the negotiation A and which includes the plurality of deadlines AI-A. As described above, the agreement candidate proposal AI-A includes the proposed quantities AI-A which correspond to the respective deadlines AI-A. Further, the agreement candidate proposal generating section 13 generates the agreement candidate proposal AI-B which is to be provided to the supplier B in the negotiation B and which includes the plurality of deadlines AI-B. As described above, the agreement candidate proposal AI-B includes the proposed quantities AI-B which correspond to the respective deadlines AI-B.

An example of generating the agreement candidate proposal AI-A in the negotiation A, i.e., an example of the generating in a case where the negotiation apparatus 10 is on the product order accepting side is described here. For example, the agreement candidate proposal generating section 13 determines, as at least one of the plurality of deadlines AI-A, a point in time at which a corresponding one of the cumulative valid stock quantities falls below a corresponding one of the client A's pre-negotiation cumulative planned delivery quantities U-A. In addition, the agreement candidate proposal generating section 13 determines, as the proposed quantity AI-A which corresponds to such at least one deadline AI-A, a quantity obtained by subtracting the corresponding pre-negotiation cumulative planned delivery quantity U-A from the corresponding cumulative valid stock quantity at the at least one deadline AI-A. Note that in a case where a delivery plan is not particularly determined before the start of the negotiation A, a quantity of zero may be applied as the corresponding pre-negotiation cumulative planned delivery quantity U-A.

The agreement candidate proposal generating section 13 determines, as at least another one of the plurality of deadlines AI-A, one of the plurality of deadlines U-A proposed by the client A. Further, the agreement candidate proposal generating section 13 determines, as the proposed quantity AI-A which corresponds to the at least another one of the plurality of deadlines AI-A, the proposed quantity U-A which corresponds to the one deadline U-A.

In a case where the agreement candidate proposal AI-A is not a counter offer made in response to the client A's agreement candidate proposal U-A, deadlines A and delivery quantities A included in the order acceptance information are referred to instead of the deadlines U-A and the proposed quantities U-A.

An example of generating the agreement candidate proposal AI-B in the negotiation B, i.e., an example of the generating in a case where the negotiation apparatus 10 is on the product order placing side is described here. For example, the agreement candidate proposal generating section 13 determines, as at least one of the plurality of deadlines AI-B, a point in time at which a corresponding one of the cumulative required quantities exceeds a corresponding one of the pre-negotiation cumulative planned delivery quantities U-B. In addition, the agreement candidate proposal generating section 13 determines, as the proposed quantity AI-B which corresponds to such at least one deadline AI-B, a quantity obtained by subtracting the corresponding pre-negotiation cumulative planned delivery quantity U-B from the corresponding cumulative required quantity at the at least one deadline AI-B. Note that in a case where a delivery plan is not particularly determined before the start of the negotiation B, a quantity of zero may be applied as the corresponding pre-negotiation cumulative planned delivery quantity U-B.

The agreement candidate proposal generating section 13 determines, as at least another one of the plurality of deadlines AI-B, one of the plurality of deadlines U-B included in the agreement candidate proposal U-B from the supplier B. Further, the agreement candidate proposal generating section 13 determines, as the proposed quantity AI-B which corresponds to the at least another one of the plurality of deadlines AI-B, the proposed quantity U-B which corresponds to the one deadline U-B.

In a case where the agreement candidate proposal AI-B is not a counter offer made in response to the supplier B's agreement candidate proposal U-B, deadlines B and delivery quantities B included in the order placement information are referred to instead of the deadlines U-B and the proposed quantities U-B.

In the negotiation A or the negotiation B, the agreement candidate proposal generating section 13 may refer to the minimum safety stock, the maximum safety stock, the safety lead time, or the standard packing quantity of the product, or a combination of some or all thereof, to generate the agreement candidate proposal AI-A or AI-B. For example, the agreement candidate proposal generating section 13 may refer to the cumulative valid stock quantities and cumulative required quantities that are calculated in consideration of a part or the whole of the stock management information, to generate the agreement candidate proposal AI-A or AI-B.

The agreement candidate proposal providing section 14 provides the client A with the agreement candidate proposal AI-A. Specifically, the agreement candidate proposal providing section 14 provides the client A with the agreement candidate proposal AI-A by transmitting this agreement candidate proposal AI-A to the negotiation apparatus 20A. Hereinafter, “providing the client A with the agreement candidate proposal AI-A” can be expressed as “transmitting the agreement candidate proposal AI-A to the negotiation apparatus 20A”.

The agreement candidate proposal providing section 14 provides the supplier B with the agreement candidate proposal AI-B. Specifically, the agreement candidate proposal providing section 14 provides the supplier B with the agreement candidate proposal AI-B by transmitting this agreement candidate proposal AI-B to the negotiation apparatus 20B. Hereinafter, “providing the supplier B with the agreement candidate proposal AI-B” can be expressed as “transmitting the agreement candidate proposal AI-B to the negotiation apparatus 20B”.

### Configuration of Negotiation Apparatus 20a

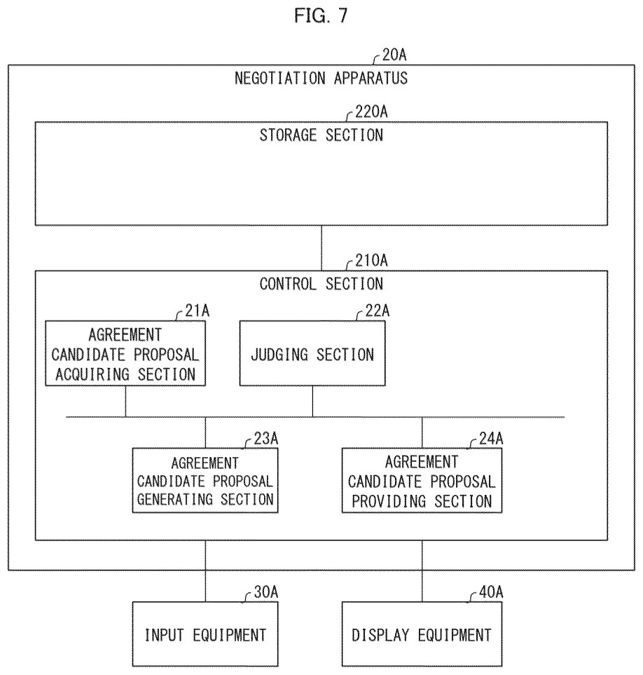

FIG. 7 is a block diagram illustrating an example functional configuration of the negotiation apparatus 20A. The negotiation apparatus 20A includes a control section 210A and a storage section 220A, as illustrated in FIG. 7. Further, the negotiation apparatus 20A is connected to input equipment 30A and display equipment 40A. The control section 210A performs overall control of the sections of the negotiation apparatus 20A. The control section 210A includes an agreement candidate proposal acquiring section 21A, a judging section 22A, an agreement candidate proposal generating section 23A, and an agreement candidate proposal providing section 24A.

The agreement candidate proposal acquiring section 21A acquires, in the negotiation A with the negotiation apparatus 10, the agreement candidate proposal AI-A which is provided by the negotiation apparatus 10 and which includes the plurality of deadlines AI-A. Specifically, the agreement candidate proposal acquiring section 21A acquires the agreement candidate proposal AI-A by receiving this agreement candidate proposal AI-A from the negotiation apparatus 10. Hereinafter, “acquiring the agreement candidate proposal AI-A provided by the negotiation apparatus 10” can be expressed as “receiving the agreement candidate proposal AI-A from the negotiation apparatus 10”.

The agreement candidate proposal acquiring section 21A displays the acquired agreement candidate proposal AI-A and agreement candidate proposal U-A on the display equipment 40A such that a comparison therebetween is possible. The agreement candidate proposal U-A is generated by the agreement candidate proposal generating section 23A, which will be described later.

The judging section 22A judges, based on an input operation performed on the input equipment 30A, whether to agree to the agreement candidate proposal AI-A.

In the negotiation A, the agreement candidate proposal generating section 23A generates, based on an operation performed via the input equipment 30A, the agreement candidate proposal U-A which includes the plurality of deadlines U-A. For example, in a case where the agreement candidate proposal AI-A received from the negotiation apparatus 10 is displayed on the display equipment 40A, the agreement candidate proposal generating section 23A generates the agreement candidate proposal U-A based on an operation of editing the agreement candidate proposal AI-A.

The agreement candidate proposal providing section 24A provides the negotiation apparatus 10 with the agreement candidate proposal U-A. Specifically, the agreement candidate proposal providing section 24A provides the negotiation apparatus 10 with the agreement candidate proposal U-A by transmitting this agreement candidate proposal U-A to the negotiation apparatus 10. Hereinafter, “providing the negotiation apparatus 10 with the agreement candidate proposal U-A” can be expressed as “transmitting the agreement candidate proposal U-A to the negotiation apparatus 10”.

### Configuration of Negotiation Apparatus 20B

The configuration of the negotiation apparatus 20B is described similarly by interchanging A with B in FIG. 7 and in the description of the negotiation apparatus 20A made with reference to FIG. 7.

### Flow of Negotiation Method S3

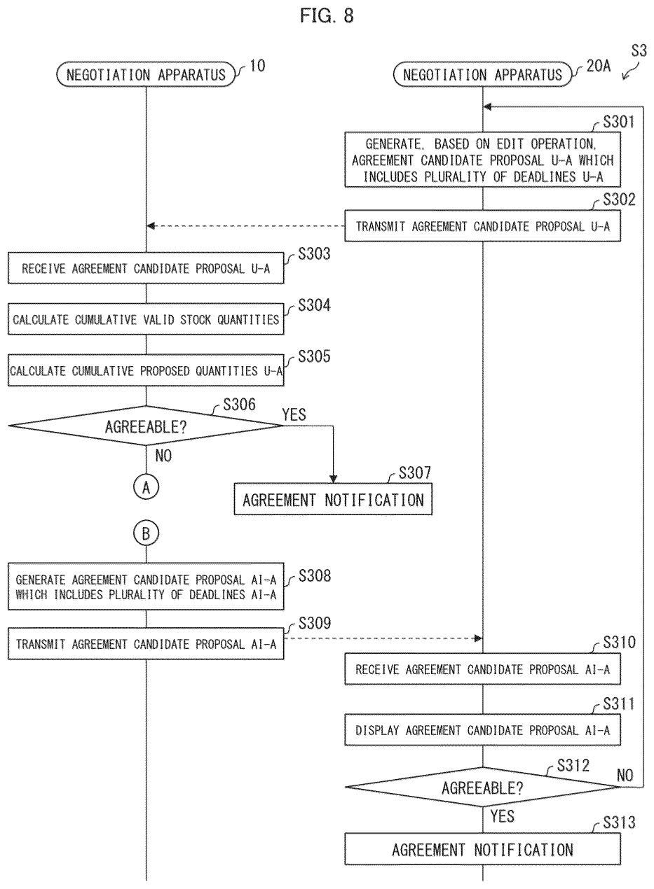

The negotiation system 100 configured as described above carries out a negotiation method S3 in accordance with the present example embodiment. The negotiation method S3 is carried out in the negotiation A. FIG. 8 is a flowchart illustrating the flow of the negotiation method S3. The negotiation method S3 includes steps S301 to S313. Among these steps, steps S303 to S309 include a method the negotiation apparatus 10 carries out as an example of the negotiation apparatus recited in the claims. Steps S301, S302, and S310 to S313 include a method the negotiation apparatus 20A carries out as an example of the negotiation apparatus recited in the claims. Further, assume that at the point in time at which the following negotiation method S3 starts, the installment delivery plan A before the start of the negotiation A is displayed on the display equipment 40A of the negotiation apparatus 20A.

In step S301, the agreement candidate proposal generating section 23A of the negotiation apparatus 20A generates, based on an operation performed via the input equipment 30A, the agreement candidate proposal U-A which includes the plurality of deadlines U-A and the proposed quantities U-A which correspond to the respective deadlines U-A. Specifically, the agreement candidate proposal generating section 23A generates the agreement candidate proposal U-A based on an operation of editing the installment delivery plan A displayed on the display equipment 40A.

In step S302, the agreement candidate proposal providing section 24A transmits the agreement candidate proposal U-A to the negotiation apparatus 10. In step S303, the agreement candidate proposal acquiring section 11 of the negotiation apparatus 10 receives the agreement candidate proposal U-A from the negotiation apparatus 20A.

In step S304, the judging section 12 calculates the cumulative valid stock quantities. For example, the agreement candidate proposal acquiring section 11 calculates, based on the agreement candidate proposal U-A from the client A, the order placement information (installment delivery plan B), and a part or the whole of the stock management information, the cumulative valid stock quantities at respective points in time in the target period.

In step S305, the judging section 12 calculates, based on the agreement candidate proposal U-A from the client A, the cumulative proposed quantities U-A by respective points in time in the target period. Note that the sequence in which the processes of steps S304 and S305 are carried out is not limited to the sequence described above, but these processes may be carried out in a reverse sequence or may be carried out in parallel.

In step S306, the judging section 12 judges whether to agree to the agreement candidate proposal U-A from the client A. For example, if the cumulative proposed quantities U-A are equal to or smaller than the respective cumulative valid stock quantities at all the points in time in the target period, then the judging section 12 judges that the agreement candidate proposal U-A is agreeable, otherwise the judging section 12 judges that the agreement candidate proposal U-A is not agreeable.

In a case of the judgment that the agreement candidate proposal U-A is agreeable in step S306, the control section 110 transmits agreement notification information to the negotiation apparatus 20A in step S307. The negotiation method S3 (negotiation A) then ends. In a case of the judgment that the agreement candidate proposal U-A is not agreeable in step S306, the negotiation system 100 temporarily suspends the negotiation method S3, and starts a negotiation method S4 (negotiation B), which will be described later. In a case where in the negotiation B, the negotiation apparatus 10 judges that the agreement candidate proposal U-B is not agreeable, the negotiation system 100 resumes the negotiation method S3 (negotiation A) at step S308.

In step S308, the agreement candidate proposal generating section 13 of the negotiation apparatus 10 refers to the cumulative valid stock quantities and the pre-negotiation cumulative planned delivery quantities U-A to generate the agreement candidate proposal AI-A (counter offer). Specifically, the agreement candidate proposal generating section 13 generates pair information 1 indicating [deadlines U-A included in the agreement candidate proposal U-A from the client A, proposed quantities U-A corresponding to the respective deadlines U-A]. Further, the agreement candidate proposal generating section 13 generates pair information 2 indicating [a point in time at which the cumulative valid stock quantity falls below the pre-negotiation cumulative planned delivery quantity U-A, a quantity obtained by subtracting the pre-negotiation cumulative planned delivery quantity U-A from the cumulative valid stock quantity at the point in time]. Furthermore, the agreement candidate proposal generating section 13 generates the agreement candidate proposal AI-A which includes the pair information 1 and the pair information 2.

In step S309, the agreement candidate proposal providing section 14 transmits the generated agreement candidate proposal AI-A to the negotiation apparatus 20A. In step S310, the agreement candidate proposal acquiring section 21A of the negotiation apparatus 20A receives the agreement candidate proposal AI-A from the negotiation apparatus 10. In step S311, the agreement candidate proposal acquiring section 21A displays the acquired agreement candidate proposal AI-A and the agreement candidate proposal U-A transmitted in step S301 on the display equipment 40A such that a comparison therebetween is possible.

In step S312, the judging section 22A judges, based on an operation performed via the input equipment 30A, whether to agree to the agreement candidate proposal AI-A. That is, the client A sees the agreement candidate proposal AI-A displayed on the display equipment 40A, and performs the operation of inputting, via the input equipment 30A, whether to agree.

In a case of the judgment that the agreement candidate proposal AI-A is agreeable in step S312, the control section 210A transmits the agreement notification information to the negotiation apparatus 10. The negotiation method S3 then ends. In a case of the judgment that the agreement candidate proposal AI-A is not agreeable in step S312, the negotiation system 100 repeats the processes of step S301 and the subsequent steps.

In step S301 carried out in the repeated processes, the agreement candidate proposal generating section 23A of the negotiation apparatus 20A generates, based on an operation of editing the agreement candidate proposal AI-A, the agreement candidate proposal U-A which includes a plurality of new deadlines U-A and new proposed quantities U-A which correspond to the respective deadlines U-A. In this step, the agreement candidate proposal U-A previously generated and the agreement candidate proposal AI-A are displayed on the display equipment 40A such that a comparison between therebetween is possible. The client A performs an operation of editing the displayed agreement candidate proposal AI-A in order to generate a new agreement candidate proposal U-A (counter offer). The processes of step S302 and the subsequent steps are then repeated.

### Variation of Negotiation Method S3

In the negotiation method S3, the negotiation apparatus 10 is described as generating, in a case where the agreement candidate proposal U-A from the client A is not agreeable, the agreement candidate proposal AI-A as a counter offer made in response to the agreement candidate proposal U-A. The generation of the agreement candidate proposal AI-A is not limited to this, but the negotiation apparatus 10 may generate the agreement candidate proposal AI-A and provide the client A with the same before the acquisition of the agreement candidate proposal U-A from the client A. In this case, the process of generating the agreement candidate proposal AI-A (offer) is described similarly by interchanging the agreement candidate proposal U-A, the deadlines U-A, and the proposed quantities U-A respectively with the installment delivery plan A, the deadlines A, and the delivery quantities A, in the description of the process of generating the agreement candidate proposal AI-A (counter offer) in step S308.

### Flow of Negotiation Method S4

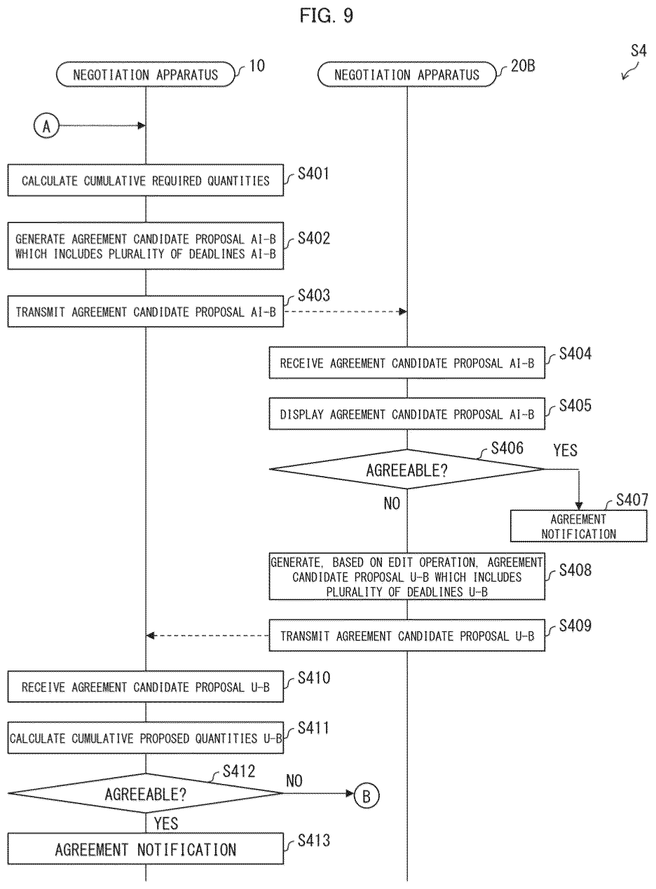

The negotiation system 100 configured as described above carries out a negotiation method S4 in accordance with the present example embodiment. The negotiation method S4 is carried out in the negotiation B. The negotiation method S4 is started by the negotiation apparatus 10 in a case where the negotiation apparatus 10 does not agree to the agreement candidate proposal U-A in the negotiation A (No in step S306 of the negotiation method S3). FIG. 9 is a flowchart illustrating the flow of the negotiation method S4. The negotiation method S4 includes steps S401 to S413. Among these steps, steps S401 to S403 and S410 to S413 include a method the negotiation apparatus 10 carries out as an example of the negotiation apparatus recited in the claims. Further, steps S404 to S409 include a method the negotiation apparatus 20B carries out as an example of the negotiation apparatus recited in the claims.

In step S401, the agreement candidate proposal generating section 13 of the negotiation apparatus 10 calculates, based on the agreement candidate proposal U-A from the client A, cumulative required quantities of the product at respective points in time in the target period.

In step S402, the agreement candidate proposal generating section 13 refers to the cumulative required quantities and the pre-negotiation cumulative planned delivery quantities U-B, to generate the agreement candidate proposal AI-B. Specifically, the agreement candidate proposal generating section 13 generates pair information 3 indicating [deadlines B included in the installment delivery plan B, delivery quantities B corresponding to the deadlines B]. Further, the agreement candidate proposal generating section 13 generates pair information 4 indicating [a point in time at which the cumulative required quantity exceeds the pre-negotiation cumulative planned delivery quantity U-B, a quantity obtained by subtracting the pre-negotiation cumulative planned delivery quantity U-B from the cumulative required quantity]. Furthermore, the agreement candidate proposal generating section 13 generates the agreement candidate proposal AI-B which includes the pair information 3 and the pair information 4.

In step S403, the agreement candidate proposal providing section 14 transmits the generated agreement candidate proposal AI-B to the negotiation apparatus 20B. In step S404, the agreement candidate proposal acquiring section 21B of the negotiation apparatus 20B receives the agreement candidate proposal AI-B from the negotiation apparatus 10. In step S405, the agreement candidate proposal acquiring section 21B displays the acquired agreement candidate proposal AI-B and a delivery plan B on the display equipment 40B such that a comparison therebetween is possible. Note that the delivery plan B is included in the order placement information stored in the storage section 120 of the negotiation apparatus 10. The delivery plan B may be transmitted from the negotiation apparatus 10 together with the agreement candidate proposal AI-B, and displayed on the display equipment 40B, accordingly.

In step S406, the judging section 22B judges, based on an operation performed via the input equipment 30B, whether to agree to the agreement candidate proposal AI-B. That is, the supplier B sees the agreement candidate proposal AI-B displayed on the display equipment 40B, and performs the operation of inputting, via the input equipment 30B, whether to agree.

In a case of the judgment that the agreement candidate proposal AI-B is agreeable in step S406, the control section 210B transmits agreement notification information to the negotiation apparatus 10 in step S407. The negotiation method S4 then ends. Further, in this case, the negotiation apparatus 10 carries out step S307 in the negotiation method S3, and transmits the agreement notification information to the negotiation apparatus 20A. The negotiation method S3 then ends. In a case of the judgment that the agreement candidate proposal AI-B is not agreeable in step S406, step S408 is carried out.

In step S408, on the basis of an operation, performed via the negotiation apparatus 10, of editing the agreement candidate proposal AI-B, the agreement candidate proposal generating section 23B of the negotiation apparatus 20B generates the agreement candidate proposal U-B (counter offer) which includes the plurality of deadlines U-B and the proposed quantities U-B corresponding to the respective deadlines U-B. In this step, the installment delivery plan B before the start of the negotiation B and the agreement candidate proposal AI-B are displayed on the display equipment 40B such that a comparison therebetween is possible. The supplier B performs an operation of editing the displayed agreement candidate proposal AI-B in order to generate the agreement candidate proposal U-B (counter offer).

In step S409, the agreement candidate proposal providing section 24B transmits the agreement candidate proposal U-B to the negotiation apparatus 10. In step S410, the agreement candidate proposal acquiring section 11 of the negotiation apparatus 10 receives the agreement candidate proposal U-B from the negotiation apparatus 20B.

In step S411, the judging section 12 calculates the cumulative proposed quantities U-B based on the agreement candidate proposal U-B from the supplier B. In step S412, the judging section 12 judges whether to agree to the agreement candidate proposal U-B from the supplier B. For example, if the cumulative proposed quantities U-B are equal to or greater than the respective cumulative required quantities at all the points in time in the target period, then the judging section 12 judges that the agreement candidate proposal U-A is agreeable, otherwise the judging section 12 judges that the agreement candidate proposal U-A is not agreeable.

In a case of the judgment that the agreement candidate proposal U-B is agreeable in step S412, the control section 110 transmits agreement notification information to the negotiation apparatus 20B in step S413. The negotiation method S4 (negotiation B) then ends. In a case of the judgment that the agreement candidate proposal U-A is not agreeable in step S412, the negotiation system 100 temporarily suspends the negotiation method S4 (negotiation B), and resumes the above-described negotiation method S3 (negotiation A) at step S308.

### Supplement to Negotiation Method S4

In the description of step S402 described above, the agreement candidate proposal AI-B (offer) to be provided to the supplier B is generated before the reception of the agreement candidate proposal U-B from the supplier B. However, in some cases, step S402 is carried out again in order to generate the agreement candidate proposal AI-B as a counter offer made in response to the agreement candidate proposal U-B from the supplier B.

Specifically, in a case where a return to the negotiation method S3 (negotiation A) is made because of a No determination in step S406 and a No determination in step S412, if the judgment in S312 is No and the judgment in S306 is No, then the negotiation method S4 (negotiation B) is carried out again and step S402 is thus carried out again. In this case, in step S402, the agreement candidate proposal AI-B (counter offer) is generated. The process of generating the agreement candidate proposal AI-B (counter offer) is described similarly by interchanging the installment delivery plan B, the deadlines B, and the delivery quantities B with the agreement candidate proposal U-B, the deadlines U-B, and the proposed quantities U-B in the description of the process of generating the agreement candidate proposal AI-B (offer) in step S402 described above.

### Specific Example of Negotiation Methods S3 and S4

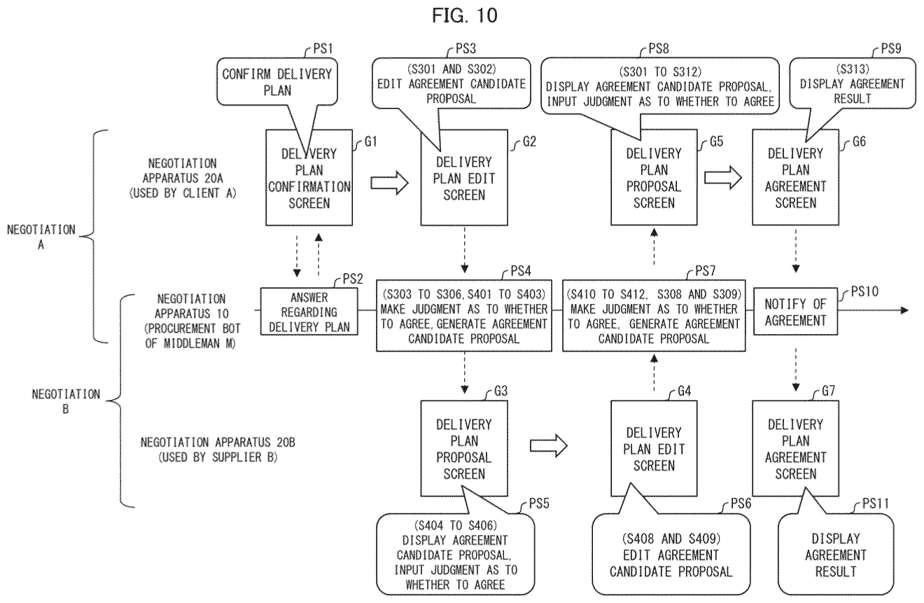

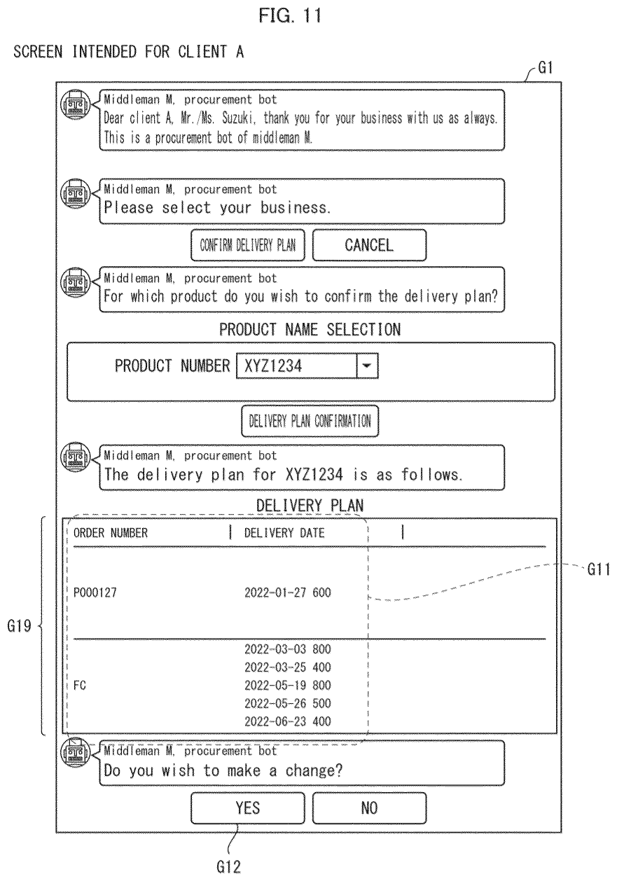

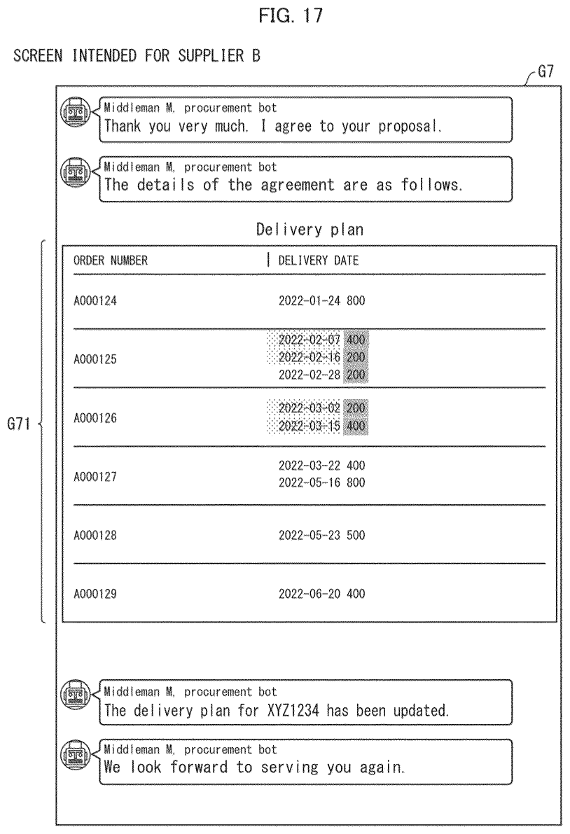

Next, a specific example of the negotiation A and the negotiation B which are carried out with use of the negotiation methods S3 and S4 is described here with reference to FIGS. 10 to 17. FIG. 10 is a diagram illustrating a specific example of a transition of screens and processes in the negotiation A and the negotiation B. FIGS. 11 to 17 are diagrams illustrating detailed examples of the respective screens illustrated in FIG. 10. Note that the transition and screens are presented by way of example, and in no way limit the present example embodiment.

The status in the specific example is such that the client A places an order for a product with the middleman M, and a delivery has not yet been made. In addition, the status is such that an order for the product to be delivered to the client A is placed by the middleman M with the supplier B, and a delivery has not yet been made. The negotiation apparatus 10 functions as a procurement bot of the middleman M. Further, the client A wishes to change the installment delivery plan A, and the negotiation A for changing the installment delivery plan A is conducted between the client A and the negotiation apparatus 10. Further, in response to the negotiation A, the negotiation B for changing the installment delivery plan B is conducted between the negotiation apparatus 10 and the supplier B.

In FIG. 10, the upper row indicates the transition of screens displayed in the negotiation A by the negotiation apparatus 20A, which is used by the client A. Hereinafter, these screens are also expressed as screens intended for the client A. The middle row indicates the transition of processes carried out by the negotiation apparatus 10, which is the procurement bot of the middleman M. The lower row indicates the transition of screens displayed in the negotiation B by the negotiation apparatus 20B, which is used by the supplier B. Hereinafter, these screens are also expressed as screens intended for the supplier B. The specific example includes steps PS1 to PS11. Further, the specific example includes screens G1 to G7.

As illustrated in FIG. 10, the screen G1 intended for the client A indicates a delivery plan confirmation screen. The screen G1 is displayed by carrying out steps PS1 and PS2. In step PS1, on the basis of an operation performed by the client A, the control section 210A of the negotiation apparatus 20A transmits a request for confirmation of a delivery plan of a product the order of which has been placed with the negotiation apparatus 10. In step PS2, the control section 110 of the negotiation apparatus 10 refers to order acceptance information in the storage section 120 to acquire the installment delivery plan A of the product, and transmits the delivery plan to the negotiation apparatus 20A.

FIG. 11 is a diagram illustrating a detailed example of the screen G1. As illustrated in FIG. 11, the screen G1 includes a display interface G19. The display interface G19 is in tabular form. The display interface G19 includes an order number and a pre-change delivery plan G11 as the columns of the table. The installment delivery plan A before the start of the negotiation A is included in the pre-change delivery plan G11. Further, the rows of the display interface G19 indicate the respective deadlines A and delivery quantities A corresponding to the deadlines A of the installment delivery plan A. This makes it possible to recognize the associations between the orders included in the delivery plan G11 and the respective order numbers. In this example, the order “P000127” indicates the order which has already assigned an order number “P000127”, and the order “FC” indicates the order which has not yet been assigned an order number. Upon an operation performed by the client A on an operation object G12 (“yes” button) in response to the question “Do you wish to make a change?” in the screen G1, the screen G1 transitions to the screen G2.

Next, a return to the description of FIG. 10 is made. As illustrated in FIG. 10, the screen G2 intended for the client A indicates a delivery plan edit screen. On this screen G2, step PS3 is carried out. Step PS3 includes steps S301 and S302 of the negotiation method S3. That is, the agreement candidate proposal generating section 23A of the negotiation apparatus 20A accepts an operation of editing the pre-change delivery plan G11, and transmits, to the negotiation apparatus 10, an agreement candidate proposal which includes the changed delivery plan.

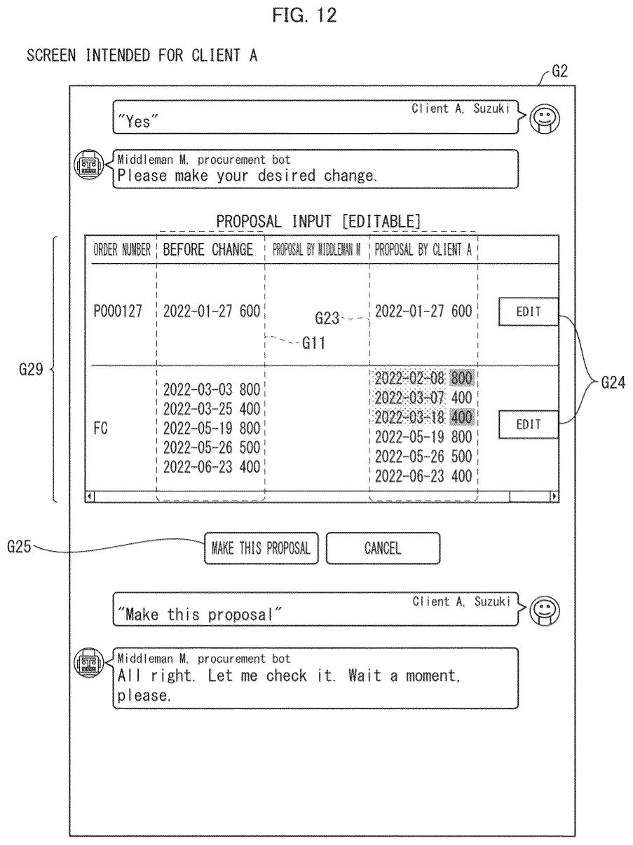

FIG. 12 is a diagram illustrating a detailed example of the screen G2. The screen G2 includes an edit interface G29. The edit interface G29 is in tabular form, and has a column of a client's proposal G23 added thereto, in comparison with the display interface G19. In other words, the edit interface G29 displays the pre-change delivery plan G11 and the client's proposal G23 such that a comparison therebetween is possible. In addition, the edit interface G29 further includes an operation object G24 (“edit” button). The client's proposal G23 includes the pre-change delivery plan G11 in a pre-edit state, and becomes editable upon an operation performed on an operation object G24. This makes it possible for the client A to edit the pre-change delivery plan G11 to input the client's proposal G23 while confirming an order number of the pre-change delivery plan G11. Further, it is possible for the client A to easily compare the pre-change delivery plan G11 with the client's proposal G23 which is being inputted by the client A.

In this example, shaded portions in the client's proposal G23 are changes from the pre-change delivery plan G11. In the screen G2, upon an operation performed on an operation object G25 (“make this proposal” button), the agreement candidate proposal providing section 24A of the negotiation apparatus 20A transmits, to the negotiation apparatus 10, the agreement candidate proposal U-A which includes the client's proposal G23.

Next, a return to the description of FIG. 10 is made. As illustrated in FIG. 10, upon reception of the agreement candidate proposal U-A which includes the client's proposal G23, the negotiation apparatus 10 carries out step PS4. Step PS4 includes steps S303 to S306 and S401 to S403 of the negotiation method S3. Described here is a case where the installment delivery plan B from the supplier B before the start of the negotiation B does not meet the client's proposal G23.

Specifically, on the basis of the installment delivery plan B from the supplier B before the start of the negotiation B and the agreement candidate proposal U-A from the client A, the judging section 12 of the negotiation apparatus 10 calculates the cumulative valid stock quantities and the cumulative proposed quantities U-A. Further, the judging section 12 judges that the agreement candidate proposal U-A is not agreeable because at at least some points in time in the target period, the cumulative proposed quantity U-A exceeds the cumulative valid stock quantity. Thus, the agreement candidate proposal generating section 13 calculates the cumulative required quantities based on the agreement candidate proposal U-A, and generates the agreement candidate proposal AI-B based on the information calculated. The details of the process of generating the agreement candidate proposal AI-B are as described in step S402. The agreement candidate proposal AI-B includes a middleman's proposal for having the supplier B change the installment delivery plan B such that the installment delivery plan B meets the client's proposal G23. The agreement candidate proposal providing section 14 of the negotiation apparatus 10 transmits, to the negotiation apparatus 20B, the agreement candidate proposal AI-B generated.

Next, the negotiation apparatus 20B carries out step PS5. Step PS5 includes steps S404 to S406 of the negotiation method S4. That is, the agreement candidate proposal acquiring section 21B of the negotiation apparatus 20B displays the agreement candidate proposal AI-B received. This causes the screen G3 intended for the supplier B to be displayed. Further, the judging section 22B judges, based on an input via the input equipment 30B, whether to agree to the agreement candidate proposal AI-B.

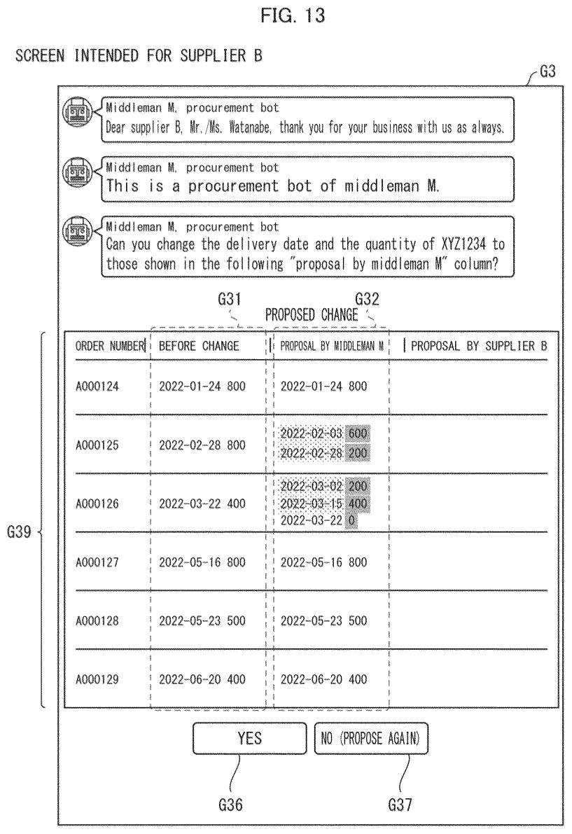

The screen G3 intended for the supplier B is a delivery plan proposal screen. The screen G3 indicates the agreement candidate proposal AI-B received from the negotiation apparatus 10. FIG. 13 is a diagram illustrating a detailed example of the screen G3. The screen G3 includes a display interface G39. The display interface G39 is in tabular form. The display interface G39 includes an order number, a pre-change delivery plan G31, and a middleman's proposal G32 as the columns of the table. The installment delivery plan B before the start of the negotiation B is included in the pre-change delivery plan G31. Further, the rows of the display interface G39 indicate the respective deadlines A and the quantities of a product corresponding to the deadlines A. This makes it possible to recognize the associations between the orders included in the delivery plan G31 and the respective order numbers. In this example, in relation to each of order numbers A000124 to A000129, it is possible to compare the pre-change delivery plan G31 and the middleman's proposal G32.

The pre-change delivery plan G31 has been set in consideration of a stock quantity, a lead time, etc. at the middleman M, according to the pre-change delivery plan G11 for delivering the product to the client A. The middleman's proposal G32 is information included in the agreement candidate proposal AI-B. The middleman's proposal G32 differs from the delivery plan G31 in the shaded portions. This makes it possible for the supplier B to easily compare the pre-change delivery plan G31 and the middleman's proposal G52.

Assume here that the supplier B does not agree to the middleman's proposal G32, and an operation object G37 (“no (propose again)” button) is operated on the screen G3. Upon the operation on the operation object G37, the screen G3 transitions to the screen G4.

Next, a return to the description of FIG. 10 is made. As illustrated in FIG. 10, the screen G4 intended for the supplier B indicates a delivery plan edit screen. On this screen G4, step PS6 is carried out. Step PS6 includes steps S408 and S409 of the negotiation method S4. That is, in step PS6, the agreement candidate proposal generating section 23B of the negotiation apparatus 20B accepts an operation of editing the delivery plan G31 displayed, and transmits, to the negotiation apparatus 10, the agreement candidate proposal U-B that includes the delivery plan which has changes made thereto.

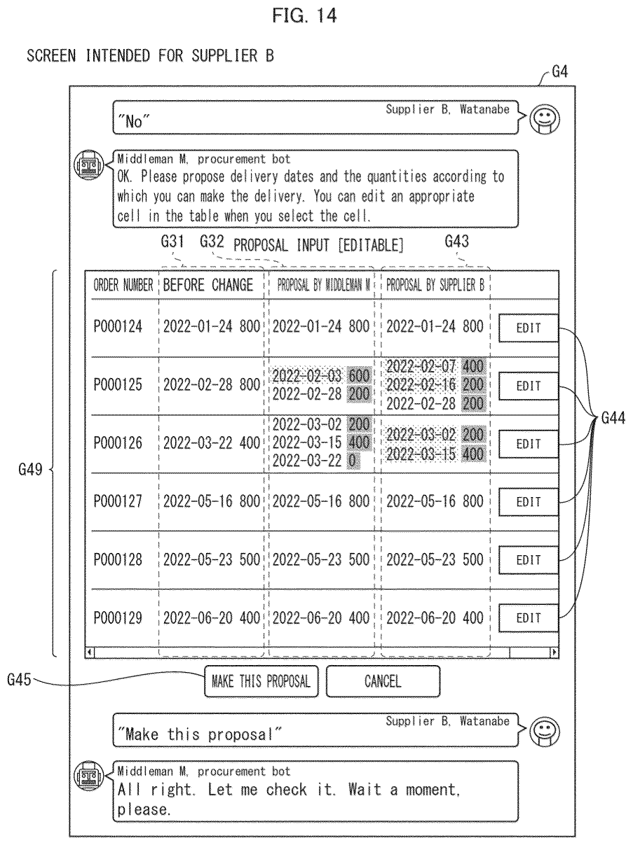

FIG. 14 is a diagram illustrating a detailed example of the screen G4. The screen G4 includes an edit interface G49. The edit interface G49 is in tabular form, and has added thereto a column of a supplier's proposal G43 and an operation object G44 (“edit button”), in comparison with the display interface G39. In other words, in the edit interface G49, the pre-change delivery plan G31, the middleman's proposal G32, and the supplier's proposal G43 are displayed such that a comparison therebetween is possible. The supplier's proposal G43 includes the middleman's proposal G32 in a pre-edit state, and becomes editable upon an operation performed on an operation object G44. This makes it possible for the supplier B to edit the pre-change delivery plan G31 to input the supplier's proposal G43 while confirming an order number of the pre-change delivery plan G31. It is also possible for the supplier B to easily compare the pre-change delivery plan G31, the middleman's proposal G32, and the supplier's proposal G43 which is being inputted by the supplier B.

In this example, shaded portions in the supplier's proposal G43 are changes from the middleman's proposal G42. In the screen G4, upon an operation performed on an operation object G45 (“make this proposal” button), the agreement candidate proposal providing section 24B of the negotiation apparatus 20B transmits, to the negotiation apparatus 10, the agreement candidate proposal U-B which includes the supplier's proposal G43.

Next, a return to the description of FIG. 10 is made. As illustrated in FIG. 10, upon reception of the agreement candidate proposal U-B which includes the supplier's proposal G43, the negotiation apparatus 10 carries out step PS7. Step PS7 include steps S410 to S412, S308, and S309 of the negotiation method S3. Described here is a case where the agreement candidate proposal U-B from the supplier B does not meet the client's proposal G23.

Specifically, the judging section 12 of the negotiation apparatus 10 calculates the cumulative proposed quantities U-B based on the agreement candidate proposal U-B from the supplier B. The judging section 12 refers to the quantities calculated based on the agreement candidate proposal U-A from the client A in step PS4, as the cumulative required quantities. The judging section 12 judges that the agreement candidate proposal U-B is not agreeable because at at least some points in time in the target period, the cumulative proposed quantity U-B is smaller than the cumulative required quantity. Thus, the agreement candidate proposal generating section 13 calculates the cumulative valid stock quantities based on the agreement candidate proposal U-B, and generates the agreement candidate proposal AI-A based on these pieces of information calculated. The details of the process of generating the agreement candidate proposal AI-A are as described in step S308. The agreement candidate proposal AI-A includes the middleman's proposal for sounding the client A out about a change in the client's proposal G23 so as to bring the client's proposal G23 into conformity to the supplier's proposal G43. Further, the agreement candidate proposal providing section 14 of the negotiation apparatus 10 transmits, to the negotiation apparatus 20A, the agreement candidate proposal AI-A generated.

Next, the negotiation apparatus 20A carries out step PS8. Step PS8 includes steps S310 to S312 of the negotiation method S2. That is, the agreement candidate proposal acquiring section 21A of the negotiation apparatus 20A displays the agreement candidate proposal AI-A received. This causes the screen G5 intended for the client A to be displayed. Further, the judging section 22A judges, based on an input via the input equipment 30A, whether to agree to the agreement candidate proposal AI-A.

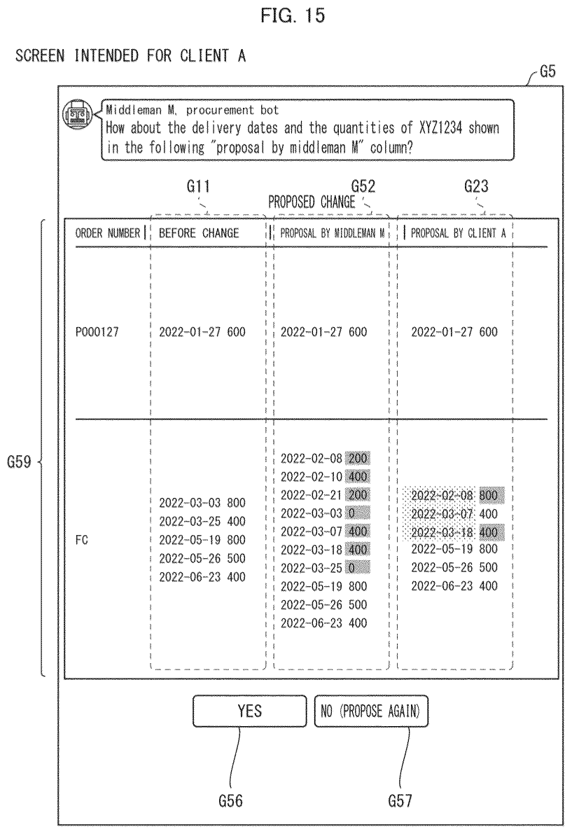

The screen G5 intended for the client A is a delivery plan proposal screen. The screen G5 indicates the agreement candidate proposal AI-A received from the negotiation apparatus 10. FIG. 15 is a diagram illustrating a detailed example of the screen G5. The screen G5 includes a display interface G59. The display interface G59 is in tabular form, and has a column of the middleman's proposal G52 added thereto, in comparison with edit interface G29. In other words, the display interface G59 displays the pre-change delivery plan G11, the client's proposal G23, and the middleman's proposal G52 such that a comparison therebetween is possible. The middleman's proposal G52 is information included in the agreement candidate proposal AI-A. The middleman's proposal G52 differs from the client's proposal G23 in the shaded portions. This makes it possible for the client A to easily compare the pre-change delivery plan G11, the client's proposal G23 having been proposed by the client A, and the middleman's proposal G52 received as a counter offer made in response to the client's proposal G23.

Assume here that the client A agrees to the middleman's proposal G52, and an operation object G56 (“yes” button) is operated on the screen G5. Upon the operation on the operation object G56, the screen G5 transitions to the screen G6.

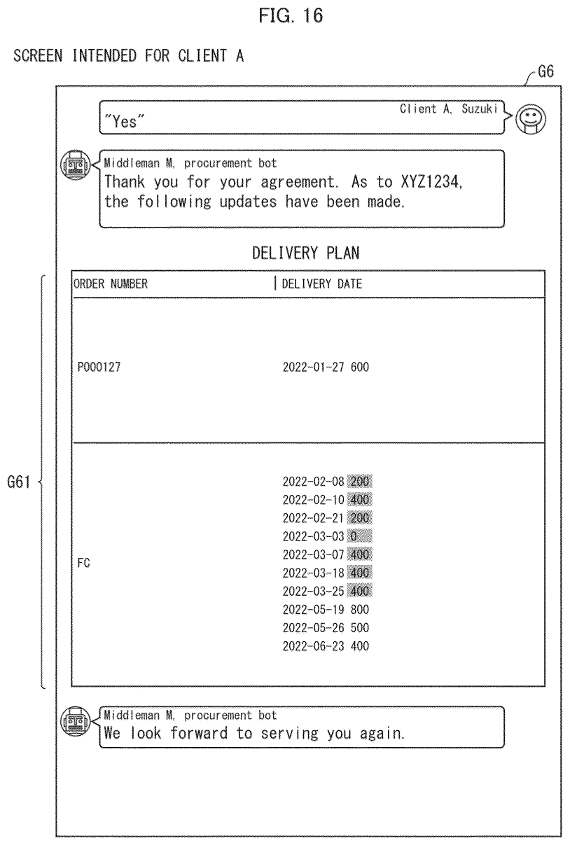

Next, a return to the description of FIG. 10 is made. As illustrated in FIG. 10, the screen G6 intended for the client A indicates a delivery plan agreement screen. The negotiation apparatus 20A carries out step PS9 so that the screen G6 is displayed. Step PS9 includes step S313 of the negotiation method S3. That is, in step PS9, the judging section 22A transmits, to the negotiation apparatus 10, the agreement (agreement notification information) to the agreement candidate proposal AI-A on the basis of an input via the input equipment 30A. Further, the control section 210A of the negotiation apparatus 20A displays the screen G6 for indicating an agreement result. FIG. 16 is a diagram illustrating a detailed example of the screen G6 intended for the client A. As illustrated in FIG. 16, the screen G6 includes a delivery plan G61 which is an agreed delivery plan. As the delivery plan G61, the middleman's proposal G52 is applied. Note that in a case where an input operation is performed via an operation object G57 (“no (propose again)” button) on the screen G5, the processes of step PS3 and the subsequent steps are repeated in the present specific example.

A return to the description of FIG. 10 is made. In step PS10, upon reception of the agreement from the negotiation apparatus 20A, the control section 110 of the negotiation apparatus 10 transmits, to the negotiation apparatus 20B in the negotiation B, an indication of agreement to the agreement candidate proposal U-B which includes the supplier's proposal G43.

Next, the negotiation apparatus 20B carries out step PS11. In step PS11, upon reception of the agreement to the agreement candidate proposal from the negotiation apparatus 10, the control section 210B of the negotiation apparatus 20B displays the screen G7 for indicating an agreement result. FIG. 14 is a diagram illustrating a detailed example of the screen G7 intended for the supplier B. As illustrated in FIG. 14, the screen G6 includes a delivery plan G71 which is an agreed delivery plan. As the delivery plan G71, the supplier's proposal G43 is applied.

### Example Advantage of Present Example Embodiment

With the configuration in accordance with the present example embodiment, the negotiation apparatuses 10, 20A, and 20B include the agreement candidate proposal acquiring sections 11, 21A, and 21B for acquiring an agreement candidate proposal which includes a plurality of deadlines and the judging sections 12, 22A, and 22B for judging whether to agree to the acquired agreement candidate proposal which includes the plurality of deadlines. Further, the negotiation apparatuses 10, 20A, and 20B include the agreement candidate proposal generating sections 13, 23A, and 23B for generating an agreement candidate proposal which includes a plurality of deadlines and the agreement candidate proposal providing sections 14, 24A, and 24B for providing the generated agreement candidate proposal which includes the plurality of deadlines. With this configuration, in a negotiation which includes a plurality of deadlines, it is possible to carry out provision/acquisition of the agreement candidate proposals between negotiation parties.

With the configuration in accordance with the present example embodiment, in the negotiation apparatuses 20A and 20B, the agreement candidate proposal acquiring sections 21A and 22B display, on the display equipment 40A and 40B, the acquired agreement candidate proposals AI-A and AI-B and the provided agreement candidate proposals U-A and U-B such that a comparison of the agreement candidate proposals AI-A and AI-B with the agreement candidate proposals U-A is possible. With this configuration, it is possible for the negotiation parties U-A and U-B which use the negotiation apparatuses 20A and 20B to easily compare the agreement candidate proposals AI-A and AI-B acquired from negotiating partners with the agreement candidate proposals U-A and U-B provided to the negotiating partners.

With the configuration in accordance with the present example embodiment, in the negotiation apparatuses 20A and 20B, the agreement candidate proposal generating sections 23A and 23B generate new agreement candidate proposals U-A and U-B based on an operation of editing the acquired agreement candidate proposals AI-A and AI-B. With this configuration, it is possible for the negotiation parties U-A and U-B which use the negotiation apparatuses 20A and 20B to easily generate the new agreement candidate proposals U-A and U-B by editing portions of the agreement candidate proposals AI-A and AI-B acquired from the negotiating partners, the portions not being agreeable.

With the configuration in accordance with the present example embodiment, in a case where the negotiation apparatus 10 conducts the negotiation A regarding acceptance of an order for a product, the judging section 12 judges whether to agree to the acquired agreement candidate proposal U-A, on the basis of the result of comparison of cumulative proposed quantities U-A at respective points in time in the target period, the cumulative proposed quantities U-A being calculated from the acquired agreement candidate proposal U-A, with cumulative valid stock quantities of the product at the respective points in time in the target period. With this configuration, it is possible to accurately judge whether to agree to the agreement candidate proposal U-A which includes an installment delivery plan regarding acceptance of an order for a product.

With the configuration in accordance with the present example embodiment, in a case where the negotiation apparatus 10 conducts the negotiation B regarding placement of an order for a product, the judging section 12 judges whether to agree to the acquired agreement candidate proposal U-B, on the basis of the result of comparison of cumulative proposed quantities U-B at respective points in time in the target period, the cumulative proposed quantities U-B being calculated from the acquired agreement candidate proposal U-B, with cumulative required quantities at the respective points in time in the target period. With this configuration, it is possible to accurately judge whether to agree to the agreement candidate proposal U-B which includes an installment delivery plan regarding placement of an order for a product.

With the configuration in accordance with the present example embodiment, in a case where the negotiation apparatus 10 conducts the negotiation A and the negotiation B regarding acceptance/placement of an order for a product, the judging section 12 refers to the minimum safety stock quantity, the maximum safety stock quantity, the safety lead time, or the standard packing quantity of the product, or a combination of some or all thereof, to judge whether to agree to the acquired agreement candidate proposals U-A and U-B. With this configuration, it is possible to further accurately judge whether to agree to the agreement candidate proposals U-A and U-B which include an installment delivery plan regarding acceptance/placement of an order for a product.

With the configuration in accordance with the present example embodiment, in a case where the negotiation apparatus 10 conducts the negotiation A regarding acceptance of an order for a product, the agreement candidate proposal generating section 13 determines, as at least one of the plurality of deadlines AI-A which is to be included in the agreement candidate proposal AI-A, a point in time at which the cumulative valid stock quantity falls below the pre-negotiation cumulative planned delivery quantity U-A and determines, as the proposed quantity AI-A corresponding to the at least one deadline AI-A, a quantity obtained by subtracting the pre-negotiation cumulative planned delivery quantity U-A from the cumulative valid stock quantity at the at least one deadline AI-A. With this configuration, it is possible to accurately generate the agreement candidate proposal AI-A which includes an installment delivery plan regarding acceptance of an order for a product.

With the configuration in accordance with the present example embodiment, in a case where the negotiation apparatus 10 conducts the negotiation B regarding placement of an order for a product, the agreement candidate proposal generating section 13 determines, as at least one of a plurality of deadlines AI-B which is to be included in the agreement candidate proposal AI-B, a point in time at which the cumulative required quantity exceeds the pre-negotiation cumulative planned delivery quantity U-B and determines, as a proposed quantity AI-B corresponding to the at least one deadline AI-B, a quantity obtained by subtracting the pre-negotiation cumulative planned delivery quantity U-B from the cumulative required quantity. With this configuration, it is possible to accurately generate the agreement candidate proposal AI-B which includes an installment delivery plan regarding placement of an order for a product.

With the configuration in accordance with the present example embodiment, in a case where the negotiation apparatus 10 conducts the negotiation A and the negotiation B regarding acceptance/placement of an order for a product, the agreement candidate proposal generating section 13 refers to the minimum safety stock quantity, the maximum safety stock quantity, the safety lead time, or the standard packing quantity of the product, or a combination of some or all thereof, to generate the agreement candidate proposals AI-A and AI-B. With this configuration, it is possible to accurately generate the agreement candidate proposals AI-A and AI-B which include an installment delivery plan regarding acceptance/placement of an order for a product.

### First Variation

In the third example embodiment, the process of generating/transmitting the agreement candidate proposal AI-A (AI-B) can be altered as follows. Specifically, in steps S308 and S309, the negotiation apparatus 10 may generate a plurality of agreement candidate proposals AI-A with different priorities, and transmit, to the negotiation apparatus 20A, the agreement candidate proposals AI-A that are selected according to the priorities. Further, in steps S402 and S403 of the negotiation method S4 described above, the negotiation apparatus 10 may generate a plurality of agreement candidate proposals AI-B with different priorities, and transmit, to the negotiation apparatus 20B, the agreement candidate proposals AI-B that are selected according to the priorities.

The priorities may be determined heuristically, or may be determined by a utility function. Further, given, for example, a first priority, a second priority, a third priority, . . . from the highest of the priorities to the lowest, the agreement candidate proposal providing section 14 may transmit the agreement candidate proposal AI-A with the second priority in a case where an agreement to the agreement candidate proposal AI-A (AI-B) with the first priority is not obtained, and transmit the agreement candidate proposal AI-A (AI-B) with the third priority in a case where an agreement to the agreement candidate proposal AI-A (AI-B) with the second priority is not obtained. Note that the priorities are not limited to the above-described three levels.

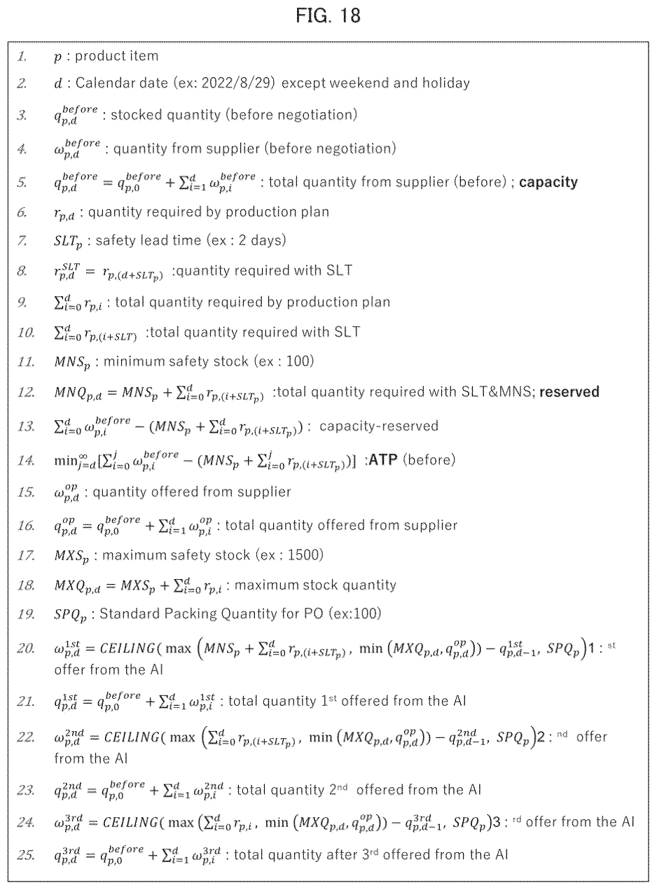

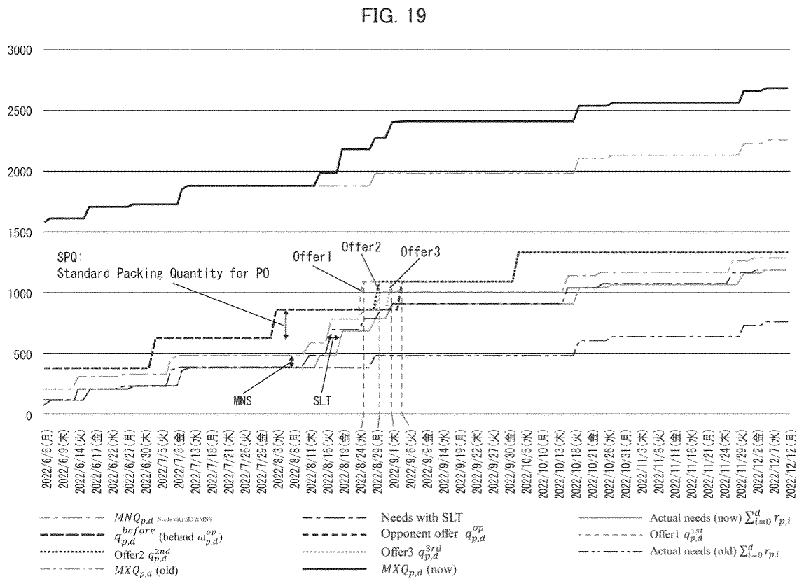

An example of the plurality of agreement candidate proposals with different priorities is described here with reference to FIGS. 18 and 19. FIG. 18 is a representation of an example algorithm for generating the plurality of agreement candidate proposals AI-B with different priorities in a case where the negotiation apparatus 10 is on the product order placing side. FIG. 19 is a graph illustrating an example of the plurality of agreement candidate proposals AI-B generated by the algorithm illustrated in FIG. 18. In this example, the priorities are determined heuristically. In FIG. 8, the 9th row indicates the cumulative required quantity for which neither a safety lead time (SLTₚ) nor a minimum safety stock quantity (MNSₚ) is taken into consideration. The 10th row indicates the cumulative required quantity for which the safety lead time is taken into consideration and the minimum safety stock quantity is not taken into consideration. The 12th row indicates the cumulative required quantity for which the safety lead time and the minimum safety stock quantity are taken into consideration. The 16th row indicates the cumulative proposed quantity U-B from the supplier B. The 20th row indicates the agreement candidate proposal AI-B with the first priority, and is generated by referring to the cumulative required quantity for which both the safety lead time and the minimum safety stock quantity are taken into consideration. The 22nd row indicate the agreement candidate proposal AI-B with the second priority, and is generated by referring to the cumulative required quantity for which the safety lead time is taken into consideration but the minimum safety stock quantity is not taken into consideration. The 24th row indicates the agreement candidate proposal AI-B with the third priority, and is generated by referring to the cumulative required quantity for which neither the safety lead time nor the minimum safety stock quantity is taken into consideration. In this example algorithm, any of the respective agreement candidate proposals AI-B with the first priority, the second priority, and the third priority is calculated in consideration of a maximum safety stock quantity (MXSₚ) and a standard packing quantity (SPQₚ).

In the graph illustrated in FIG. 19, the horizontal axis indicates points in time in the target period which is from May 5, 2022 to Dec. 12, 2022. The vertical axis indicates the quantity of a product. In FIG. 19, the line graph of “q^{op}_{p,d}” corresponds to the cumulative proposed quantity U-B from the supplier B (the 16th row of FIG. 18). A point in time at which the line graph of “q^{op}_{p,d}” rises (a point in time at which the quantity of the product increases) indicates a deadline U-B proposed by the supplier B. For example, the line graph of “q^{op}_{p,d}” rises at the point in time “Sep. 6, 2022”. This indicates that the agreement candidate proposal U-B of the supplier B includes the deadline U-B “Sep. 6, 2022”.

The line graphs of “Offer 1” to “Offer 3” indicate the cumulative proposed quantities AI-B in the agreement candidate proposals AI-B with the first priority to the third priority (the 20th, 22nd, and 24th rows of FIG. 18). Points in time at which the line graphs of “Offer 1” to “Offer 3” rise (points in time at which the quantity of the product increases) indicate deadlines AI-B to be proposed to the supplier B as counter offers. For example, the line graph of “Offer 1” rises at the point in time “Aug. 24, 2022” at which the line graph of “MNQ_{p,d}” (cumulative required quantity for which the safety lead time and the minimum safety stock quantity are taken into consideration; the 12th row of FIG. 18) exceeds the line graph of “q^{op}_{p,d}” (cumulative proposed quantity U-B) for the first time. That is, the agreement candidate proposal AI-B of “Offer 1” includes the deadline AI-B “Aug. 24, 2022”, which is earlier than the deadline U-B “September 6” proposed by the supplier B.

For example, the line graph of “Offer 2” rises at the point in time “Aug. 29, 2022” at which the line graph of “Needs with SLT” (cumulative required quantity for which the safety lead time is taken into consideration and the minimum safety stock quantity is not taken into consideration; the 10th row of FIG. 18) exceeds the line graph of “q^{op}_{p,d}” (cumulative proposed quantity U-B) for the first time. That is, the agreement candidate proposal AI-B of “Offer 2” includes the deadline AI-B “Aug. 29, 2022”, which is earlier than the deadline U-B “September 6” proposed by the supplier B and is later than the date of “Offer 1”.

Further, for example, the line graph of “Offer 3” rises at the point in time “Sep. 1, 2022” at which the line graph of “Actual needs (now)” (cumulative required quantity for which neither the safety lead time nor the minimum safety stock quantity is taken into consideration; the 9th row of FIG. 18) exceeds the line graph of “q^{op}_{p,d}” (cumulative proposed quantity U-B) for the first time. That is, the agreement candidate proposal AI-B of “Offer 3” includes the deadline AI-B “Sep. 1, 2022”, which is earlier than the deadline U-B “September 6” proposed by the supplier B and is later than the date of “Offer 2”.

Note that in the description of FIG. 19, the “point in time at which the cumulative required quantity exceeds the cumulative proposed quantity U-B for the first time” is equivalent to the “point in time at which the cumulative required quantity exceeds the pre-negotiation cumulative planned delivery quantity U-B” in this example.

With the present variation, it is possible for the negotiation apparatus 10 to provide a negotiating partner with agreement candidate proposals AI-B in descending order of priority (i.e., in the order of convenience for the negotiation party AI) and it is possible to increase the possibility of obtaining an agreement to the agreement candidate proposal AI-B with a higher priority.

### Second Variation

In the third example embodiment, the process of judging whether to agree to an agreement candidate proposal can be altered as follows. In this variation, in step S306, on the basis of the result of comparison between the utility of the acquired agreement candidate proposal U-A and the utility of the agreement candidate proposal AI-A to be provided to the client A next, the judging section 12 of the negotiation apparatus 10 may judge whether to agree to the agreement candidate proposal AI-A. In this case, before the judging process by step S306 is carried out, the process of generating an agreement candidate proposal AI-A to be provided next is carried out.

Further, in step S412, on the basis of the result of comparison between the utility of the acquired agreement candidate proposal U-B and the utility of the agreement candidate proposal AI-B to be provided to the supplier B next, the judging section 12 of the negotiation apparatus 10 may judge whether to agree to the agreement candidate proposal U-B. In this case, before the judging process by step S412 is carried out, the process of generating an agreement candidate proposal AI-B to be provided next is carried out.

A specific example of the present variation is described here. In this specific example, the agreement candidate proposal generating section 13 generates agreement candidate proposals AI-A with the first priority and the second priority in the manner as described in the first variation, and the agreement candidate proposal providing section 14 transmits the agreement candidate proposal AI-A with the first priority to the negotiation apparatus 20A. Further, assume that the agreement candidate proposal acquiring section 11 receives an agreement candidate proposal U-A from the negotiation apparatus 20A, as a counter offer made in response to the agreement candidate proposal AI-A with the first priority. In this case, if the utility of the agreement candidate proposal U-A is higher than the utility of the agreement candidate proposal AI-A with the second priority, then the judging section 12 judges that the agreement candidate proposal U-A is agreeable, otherwise the judging section 12 judges that the agreement candidate proposal U-A is not agreeable. In a case where the judging section 12 judges that the agreement candidate proposal U-A is not agreeable, the agreement candidate proposal providing section 14 transmits the agreement candidate proposal AI-A with the second priority to the negotiation apparatus 20A. This specific example is described similarly even in a case of interchanging A with B.

Note that in step S306, on the basis of whether the utility of the acquired agreement candidate proposal U-A is greater than a threshold, the judging section 12 may judge whether to agree to the agreement candidate proposal U-A. Further, in step S412, on the basis of whether the utility of the acquired agreement candidate proposal U-B is greater than a threshold, the judging section 12 may judge whether to agree to the agreement candidate proposal U-B.

In the present variation, on the basis of the result of comparison of the utility of the acquired agreement candidate proposals U-A and U-B with the utility of the agreement candidate proposals AI-A and AI-B to be provided to the negotiation parties U-A and U-B next, the judging section 12 of the negotiation apparatus 10 judges whether to agree to the agreement candidate proposals AI-A and AI-B. With this configuration, it is possible to efficiently judge whether to agree to the agreement candidate proposals U-A and U-B.

### Third Variation

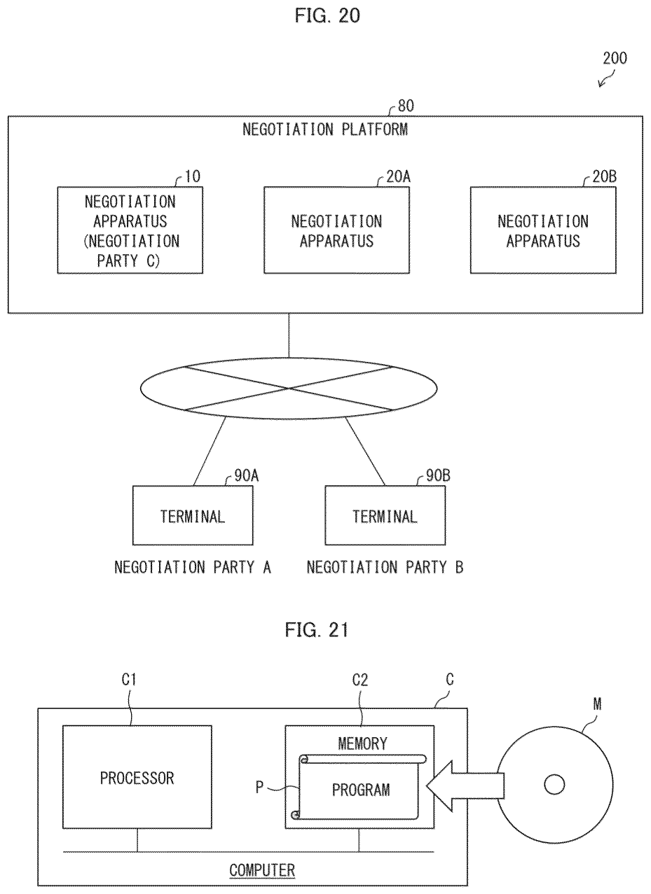

In the third example embodiment described above, the negotiation apparatus 10, the negotiation apparatus 20A, and the negotiation apparatus 20B can be altered so as to be included in a negotiation platform 80 instead of being configured as separate apparatuses which are connected together over a network. FIG. 20 is a block diagram illustrating the configuration of a negotiation system 200 in accordance with a third variation. The negotiation system 200 includes the negotiation platform 80, a terminal 90A, and a terminal 90B, as illustrated in FIG. 20. The negotiation platform 80, the terminal 90A, and the terminal 90B are communicably connected together over a network. The negotiation platform 80 includes the negotiation apparatus 10, the negotiation apparatus 20A, and the negotiation apparatus 20B.

The negotiation platform 80 includes, for example, one or more computers, and a program stored in a memory is executed so that the functions of the negotiation apparatus 10, the negotiation apparatus 20A, and the negotiation apparatus 20B are implemented. The negotiation apparatus 20A functions on the basis of an operation on the terminal 90A used by the negotiation party U-A. Further, the input equipment 30A and the display equipment 40A are connected to or included in the terminal 90A. The negotiation apparatus 20B functions on the basis of an operation on the terminal 90B used by the negotiation party U-B. Further, the input equipment 30B and the display equipment 40B are connected to or included in the terminal 90B. Further, the negotiation apparatus 10, the negotiation apparatus 20A, and the negotiation apparatus 20B may provide/acquire the agreement candidate proposals by sharing the agreement candidate proposals via a memory, instead of transmitting and receiving the agreement candidate proposals over the network. The present variation provides the same example advantage that is provided by the second example embodiment described above.

### Fourth Variation

In the third example embodiment, the product is not limited to a tangible article but may be an intangible service. In such a case, by the interchange of the “vendor”, “supplier”, etc. described above with, for example, “subcontractor” or the like, the third example embodiment is described similarly. The negotiation A and the negotiation B are not limited to negotiations regarding acceptance/placement of an order for a product, but may be other negotiations which include a plurality of deadlines. For example, the negotiation A and the negotiation B may be negotiations for coordination, among a plurality of negotiation parties, of a plurality of respective deadlines set for the steps of collaborative work carried out by the plurality of negotiation parties.

### Fifth Variation

In the third example embodiment, the negotiation apparatus 10, which is the negotiation party AI, may conduct either one or both of the negotiations A and B with another negotiation apparatus 10. Further, the negotiation apparatus 20A used by the negotiation party U-A or U-B may conduct a negotiation with the negotiation apparatus 20B used by the negotiation party U-B, regarding a plurality of deadlines.

### Software Implementation Example

Some or all of the functions of each of the negotiation apparatuses 1, 10, 20A, and 20B (hereinafter, referred to as “each apparatus”) may be implemented by hardware such as an integrated circuit (IC chip), or may be implemented by software.

In the latter case, each apparatus is provided by, for example, a computer that executes instructions of a program that is software implementing the functions. An example (hereinafter, computer C) of such a computer is illustrated in FIG. 21. The computer C includes at least one processor C1 and at least one memory C2. The memory C2 has recorded thereon a program P for causing the computer C to operate as each apparatus. The processor C1 of the computer C retrieves the program P from the memory C2 and executes the program P, so that the functions of each apparatus are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which inputting-outputting equipment such as a keyboard, a mouse, a display, or a printer is connected.

The program P can be recorded on a non-transitory tangible recording medium M capable of being read by the computer C. Examples of such a recording medium M can include a tape, a disk, a card, a semiconductor memory, and a programmable logic circuit. The computer C can obtain the program P via such a recording medium M. The program P can be transmitted via a transmission medium. Examples of such a transmission medium can include a communication network and a broadcast wave. The computer C can obtain the program P also via such a transmission medium.

### Additional Remark 1

The present invention is not limited to the above example embodiments, but may be altered in various ways by a skilled person within the scope of the claims. For example, any example embodiment derived by appropriately combining technical means disclosed in the above example embodiments is within the technical scope of the present invention.

### Additional Remark 2

The whole or part of the example embodiments disclosed above can be described as, but not limited to, the following supplementary notes.

### Supplementary Note 1

A negotiation apparatus, including:
an agreement candidate proposal acquiring means for acquiring, in a negotiation with a negotiation party which is a negotiating partner, a first agreement candidate proposal which is provided by the negotiation party and which includes a plurality of first deadlines; and
a judging means for judging whether to agree to the first agreement candidate proposal.

### Supplementary Note 2

The negotiation apparatus described in supplementary note 1, further including:
an agreement candidate proposal generating means for generating a second agreement candidate proposal which is to be provided to the negotiation party and which includes a plurality of second deadlines; and
an agreement candidate proposal providing means for providing the negotiation party with the second agreement candidate proposal.

### Supplementary Note 3

The negotiation apparatus described in supplementary note 2, in which
the agreement candidate proposal acquiring means is configured to display the first agreement candidate proposal and the second agreement candidate proposal on display equipment such that a comparison between the first agreement candidate proposal and the second agreement candidate proposal is possible.

### Supplementary Note 4

The negotiation apparatus described in supplementary note 3, in which
the agreement candidate proposal generating means is configured to generate, based on an operation of editing the first agreement candidate proposal, the second agreement candidate proposal.

### Supplementary Note 5

The negotiation apparatus described in any one of supplementary notes 1 to 4, in which
the judging means is configured to
   judge, based on a result of comparison between utility of the first agreement candidate proposal and utility of a second agreement candidate proposal to be provided to the negotiation party next, whether to agree to the first agreement candidate proposal.

### Supplementary Note 6

The negotiation apparatus described in any one of supplementary notes 1 to 4, in which
the negotiation is a negotiation regarding an order for a product accepted from the negotiation party,
the first agreement candidate proposal includes first proposed quantities of the product which are proposed for respective deliveries corresponding to the plurality of first deadlines, and
the judging means is configured to judge, based on a result of comparison between
   first cumulative proposed quantities, which each are a sum of the first proposed quantities by a corresponding point in time in a target period that includes the plurality of first deadlines, and
   cumulative valid stock quantities of the product, which each are a cumulative valid stock quantity at the corresponding point in time in the target period,
   whether to agree to the first agreement candidate proposal.

### Supplementary Note 7

The negotiation apparatus described in any one of supplementary notes 1 to 4, in which
the negotiation is a negotiation regarding an order for a product placed with the negotiation party,
the first agreement candidate proposal includes first proposed quantities of the product which are proposed for respective deliveries corresponding to the plurality of first deadlines, and
the judging means is configured to judge, based on a result of comparison between
   first cumulative proposed quantities, which each are a sum of the first proposed quantities by a corresponding point in time in a target period that includes the plurality of first deadlines, and
   cumulative required quantities of the product, which each are a sum of required quantities of the product that are required by a corresponding point in time in the target period,
   whether to agree to the first agreement candidate proposal.

### Supplementary Note 8

The negotiation apparatus described in any one of supplementary notes 1 to 4, in which
the negotiation is a negotiation with the negotiation party regarding acceptance or placement of an order for a product, and
the judging means is configured to refer to a minimum safety stock quantity, a maximum safety stock quantity, a safety lead time, or a standard packing quantity of the product, or a combination of some or all thereof, to judge whether to agree to the first agreement candidate proposal.

### Supplementary Note 9

The negotiation apparatus described in any one of supplementary notes 2 to 4, in which
the negotiation is a negotiation regarding an order for a product accepted from the negotiation party,
the first agreement candidate proposal includes first proposed quantities of the product which are proposed for respective deliveries corresponding to the plurality of first deadlines,
the second agreement candidate proposal includes second proposed quantities of the product which are proposed for respective deliveries corresponding to the plurality of second deadlines, and
the agreement candidate proposal generating means is configured to
   refer to:
   cumulative valid stock quantities of the product which each are a cumulative valid stock quantity at a corresponding point in time in a target period that includes the plurality of first deadlines; and
   pre-negotiation cumulative planned delivery quantities, which are planned before a start of the negotiation and which each are a sum of planned delivery quantities of the product to be delivered to the negotiation party by a corresponding point in time in the target period,
   to determine, as at least one of the plurality of second deadlines, a point in time at which a corresponding one of the cumulative valid stock quantities falls below a corresponding one of the pre-negotiation cumulative planned delivery quantities, and
   determine, as one of the second proposed quantities that corresponds to the at least one of the plurality of second deadlines, a quantity obtained by subtracting the corresponding one of the pre-negotiation cumulative planned delivery quantities from the corresponding one of the cumulative valid stock quantities at the at least one of the plurality of second deadlines.

### Supplementary Note 10

The negotiation apparatus described in any one of supplementary notes 2 to 4, in which
the negotiation is a negotiation regarding an order for a product placed with the negotiation party,
the first agreement candidate proposal includes first proposed quantities of the product which are proposed for respective deliveries corresponding to the plurality of first deadlines,
the second agreement candidate proposal includes second proposed quantities of the product which are proposed for respective deliveries corresponding to the plurality of second deadlines, and
the agreement candidate proposal generating means is configured to
   refer to:
   cumulative required quantities, which each are a sum of required quantities of the product that are required by a corresponding point in time in a target period that includes the plurality of first deadlines; and
   pre-negotiation cumulative planned delivery quantities, which are planned before a start of the negotiation and which each are a sum of planned delivery quantities of the product to be delivered from the negotiation party by a corresponding point in time in the target period,
   to determine, as at least one of the plurality of second deadlines, a point in time at which a corresponding one of the cumulative required quantities exceeds a corresponding one of the pre-negotiation cumulative planned delivery quantities, and
   determine, as one of the second proposed quantities that corresponds to the at least one of the plurality of second deadlines, a quantity obtained by subtracting the corresponding one of the pre-negotiation cumulative planned delivery quantities from the corresponding one of the cumulative required quantities.

### Supplementary Note 11

The negotiation apparatus described in any one of supplementary notes 2 to 4, in which
the negotiation is a negotiation with the negotiation party regarding acceptance or placement of an order for a product, and
the agreement candidate proposal generating means is configured to refer to a minimum safety stock, a maximum safety stock, a safety lead time, and a standard packing quantity of the product or a combination of some or all thereof, to generate the second agreement candidate proposal.

### Supplementary Note 12

A negotiation apparatus, including:
an agreement candidate proposal generating means for generating, in a negotiation with a negotiation party which is a negotiating partner, an agreement candidate proposal which is to be provided to the negotiation party and which includes a plurality of deadlines; and
an agreement candidate proposal providing means for providing the negotiation party with the agreement candidate proposal.

### Supplementary Note 13

A negotiation method, including:
a computer acquiring, in a negotiation with a negotiation party which is a negotiating partner, a first agreement candidate proposal which is provided by the negotiation party and which includes a plurality of first deadlines; and
the computer judging whether to agree to the first agreement candidate proposal.

### Supplementary Note 14

A negotiation method, including:
a computer generating, in a negotiation with a negotiation party which is a negotiating partner, an agreement candidate proposal which is to be provided to the negotiation party and which includes a plurality of deadlines; and
the computer providing the negotiation party with the agreement candidate proposal.

### Supplementary Note 15

A program for causing a computer to function as:
an agreement candidate proposal acquiring means for acquiring, in a negotiation with a negotiation party which is a negotiating partner, a first agreement candidate proposal which is provided by the negotiation party and which includes a plurality of first deadlines; and
a judging means for judging whether to agree to the first agreement candidate proposal.

### Supplementary Note 16

A program for causing a computer to function as:
an agreement candidate proposal generating means for generating, in a negotiation with a negotiation party which is a negotiating partner, an agreement candidate proposal which is to be provided to the negotiation party and which includes a plurality of deadlines; and
an agreement candidate proposal providing means for providing the negotiation party with the agreement candidate proposal.

### Supplementary Note 17

The whole or part of the example embodiments disclosed above can further be described as the following supplementary note.

A negotiation apparatus, including at least one processor, the at least one processor carrying out: an agreement candidate proposal acquiring process of acquiring, in a negotiation with a negotiation party which is a negotiating partner, a first agreement candidate proposal which is provided by the negotiation party and which includes a plurality of first deadlines; and a judging process of judging whether to agree to the first agreement candidate proposal.

This negotiation apparatus may further include a memory, and this memory may have stored therein a program for causing the at least one processor to carry out the agreement candidate proposal acquiring process and the judging process. Further, this program may be stored in a computer-readable non-transitory tangible recording medium.

### Supplementary Note 18

The whole or part of the example embodiments disclosed above can further be described as the following supplementary note.

A negotiation apparatus, including at least one processor, the at least one processor carrying out: an agreement candidate proposal generating process of generating, in a negotiation with a negotiation party which is a negotiating partner, an agreement candidate proposal which is to be provided to the negotiation party and which includes a plurality of deadlines; and an agreement candidate proposal providing process of providing the negotiation party with the agreement candidate proposal.

This negotiation apparatus may further include a memory, and this memory may have stored therein a program for causing the at least one processor to carry out the agreement candidate proposal generating process and the agreement candidate proposal providing process. Further, this program may be stored in a computer-readable non-transitory tangible recording medium.

### Reference Signs List

1, 2, 10, 20A, 20B: Negotiation apparatus
11, 21A, 21B: Agreement candidate proposal acquiring section
14, 24, 24A, 24B: Agreement candidate proposal providing section
12, 22A, 22B: Judging section
13, 23, 23A, 23B: Agreement candidate proposal generating section
30A, 30B: Input equipment
40A, 40B: Display equipment
80: Negotiation platform
90A, 90B: Terminal
100, 200: Negotiation system
110, 210A, 210B: Control section
120, 220A, 220B: Storage section

What is claimed is:

1. A negotiation apparatus, comprising at least one processor,
the at least one processer carrying out:
an agreement candidate proposal acquiring process for acquiring, in a negotiation with a negotiation party which is a negotiating partner, a first agreement candidate proposal which is provided by the negotiation party and which includes a plurality of first deadlines; and
a judging process for judging whether to agree to the first agreement candidate proposal.

2. The negotiation apparatus according to claim 1, the at least one processer further carrying out:
an agreement candidate proposal generating process for generating a second agreement candidate proposal which is to be provided to the negotiation party and which includes a plurality of second deadlines; and
an agreement candidate proposal providing process for providing the negotiation party with the second agreement candidate proposal.

3. The negotiation apparatus according to claim 2, wherein
in the agreement candidate proposal acquiring process, the at least one processor displays the first agreement candidate proposal and the second agreement candidate proposal on display equipment such that a comparison between the first agreement candidate proposal and the second agreement candidate proposal is possible.

4. The negotiation apparatus according to claim 3, wherein
in the agreement candidate proposal generating process, the at least one processor generates, based on an operation of editing the first agreement candidate proposal, the second agreement candidate proposal.

5. The negotiation apparatus according to claim 1, wherein
in the judging process, the at least one processor
judges, based on a result of comparison between utility of the first agreement candidate proposal and utility of a second agreement candidate proposal to be provided to the negotiation party next, whether to agree to the first agreement candidate proposal.

6. The negotiation apparatus according to claim 1, wherein
the negotiation is a negotiation regarding an order for a product accepted from the negotiation party,
the first agreement candidate proposal includes first proposed quantities of the product which are proposed for respective deliveries corresponding to the plurality of first deadlines, and
in the judging process, the at least one processor judges, based on a result of comparison between
first cumulative proposed quantities, which each are a sum of the first proposed quantities by a corresponding point in time in a target period that includes the plurality of first deadlines, and
cumulative valid stock quantities of the product, which each are a cumulative valid stock quantity at the corresponding point in time in the target period,
whether to agree to the first agreement candidate proposal.

7. The negotiation apparatus according to claim 1, wherein
the negotiation is a negotiation regarding an order for a product placed with the negotiation party,
the first agreement candidate proposal includes first proposed quantities of the product which are proposed for respective deliveries corresponding to the plurality of first deadlines, and
in the judging process, the at least one processor judge, based on a result of comparison between
first cumulative proposed quantities, which each are a sum of the first proposed quantities by a corresponding point in time in a target period that includes the plurality of first deadlines, and
cumulative required quantities of the product, which each are a sum of required quantities of the product that are required by a corresponding point in time in the target period,
whether to agree to the first agreement candidate proposal.

8. The negotiation apparatus according to claim 1, wherein
the negotiation is a negotiation with the negotiation party regarding acceptance or placement of an order for a product, and
in the judging process, the at least one processor refers to a minimum safety stock quantity, a maximum safety stock quantity, a safety lead time, or a standard packing quantity of the product, or a combination of some or all thereof, to judge whether to agree to the first agreement candidate proposal.

9. The negotiation apparatus according to any one of claim 2, wherein
the negotiation is a negotiation regarding an order for a product accepted from the negotiation party,
the first agreement candidate proposal includes first proposed quantities of the product which are proposed for respective deliveries corresponding to the plurality of first deadlines,
the second agreement candidate proposal includes second proposed quantities of the product which are proposed for respective deliveries corresponding to the plurality of second deadlines, and
in the agreement candidate proposal generating process, the at least one processor
refers to:
cumulative valid stock quantities of the product which each are a cumulative valid stock quantity at a corresponding point in time in a target period that includes the plurality of first deadlines; and
pre-negotiation cumulative planned delivery quantities, which are planned before a start of the negotiation and which each are a sum of planned delivery quantities of the product to be delivered to the negotiation party by a corresponding point in time in the target period,
to determine, as at least one of the plurality of second deadlines, a point in time at which a corresponding one of the cumulative valid stock quantities falls below a corresponding one of the pre-negotiation cumulative planned delivery quantities, and
determine, as one of the second proposed quantities that corresponds to the at least one of the plurality of second deadlines, a quantity obtained by subtracting the corresponding one of the pre-negotiation cumulative planned delivery quantities from the corresponding one of the cumulative valid stock quantities at the at least one of the plurality of second deadlines.

10. The negotiation apparatus according to any one of claim 2, wherein
the negotiation is a negotiation regarding an order for a product placed with the negotiation party,
the first agreement candidate proposal includes first proposed quantities of the product which are proposed for respective deliveries corresponding to the plurality of first deadlines,
the second agreement candidate proposal includes second proposed quantities of the product which are proposed for respective deliveries corresponding to the plurality of second deadlines, and
in the agreement candidate proposal generating process, the at least one processor:
refers to:
cumulative required quantities, which each are a sum of required quantities of the product that are required by a corresponding point in time in a target period that includes the plurality of first deadlines; and
pre-negotiation cumulative planned delivery quantities, which are planned before a start of the negotiation and which each are a sum of planned delivery quantities of the product to be delivered from the negotiation party by a corresponding point in time in the target period,
to determine, as at least one of the plurality of second deadlines, a point in time at which a corresponding one of the cumulative required quantities exceeds a corresponding one of the pre-negotiation cumulative planned delivery quantities, and
determine, as one of the second proposed quantities that corresponds to the at least one of the plurality of second deadlines, a quantity obtained by subtracting the corresponding one of the pre-negotiation cumulative planned delivery quantities from the corresponding one of the cumulative required quantities.

11. The negotiation apparatus according to any one of claim 2, wherein
the negotiation is a negotiation with the negotiation party regarding acceptance or placement of an order for a product, and
in the agreement candidate proposal generating process, the at least one processor refers to a minimum safety stock, a maximum safety stock, a safety lead time, and a standard packing quantity of the product or a combination of some or all thereof, to generate the second agreement candidate proposal.

12. A negotiation apparatus, comprising at least one processor,
the at least one processer carrying out:
an agreement candidate proposal generating process for generating, in a negotiation with the negotiation apparatus according to claim 1 as a negotiation party which is a negotiating partner, the first agreement candidate proposal which is to be provided to the negotiation party; and
an agreement candidate proposal providing process for providing the negotiation party with the first agreement candidate proposal.

13. A negotiation method, comprising:
a computer acquiring, in a negotiation with a negotiation party which is a negotiating partner, a first agreement candidate proposal which is provided by the negotiation party and which includes a plurality of first deadlines; and
the computer judging whether to agree to the first agreement candidate proposal.

14. A negotiation method, comprising:
a computer generating, in a negotiation with a computer that carries out the negotiation method according to claim 13 and that is a negotiation party which is a negotiating partner, the first agreement candidate proposal which is to be provided to the negotiation party; and
the computer providing the negotiation party with the first agreement candidate proposal.

15. A non-transitory storage medium storing a program for causing a computer to carry out:
an agreement candidate proposal acquiring process for acquiring, in a negotiation with a negotiation party which is a negotiating partner, a first agreement candidate proposal which is provided by the negotiation party and which includes a plurality of first deadlines; and
a judging process for judging whether to agree to the first agreement candidate proposal.

16. A non-transitory storage medium storing a program for causing a computer to carry out:
an agreement candidate proposal generating process for generating, in a negotiation with a computer that carries out the program stored in the storage medium according to claim 15 and that is a negotiation party which is a negotiating partner, the first agreement candidate proposal which is to be provided to the negotiation party; and
an agreement candidate proposal providing process for providing the negotiation party with the first agreement candidate proposal.
